(19) United States
(12) Patent Application Publication
(10) Pub. No.: US 2020/0324641 A1
(43) Pub. Date: Oct. 15, 2020

(54) SHUTTER DEVICE AND METHOD FOR MANUFACTURING SHUTTER DEVICE

(71) Applicant: DENSO CORPORATION, Kariya-city, Aichi-pref. (JP)

(72) Inventors: Akihiro MAEDA, Kariya-city (JP); Tsuyoshi ARAI, Kariya-city (JP); Kota KUBOTA, Kariya-city (JP); Tohru HIGUCHI, Kariya-city (JP); Yukio SHIDARA, Kariya-city (JP)

(21) Appl. No.: 16/088,981

(22) PCT Filed: Mar. 17, 2017
(86) PCT No.: PCT/JP2017/010943

§ 371 Date: Sep. 27, 2018

(30) Foreign Application Priority Data
Mar. 31, 2016 (JP) 2016-070212
Feb. 10, 2017 (JP) 2017-023047

(51) Int. Cl. B60K 11/08; B29C 45/44; B29C 45/36

(52) U.S. Cl. CPC B60K 11/085; F01P 7/10; B29C 45/36; B29C 45/4421

(57) ABSTRACT

A shutter device includes blades rotatable to interrupt an air flow therethrough, and first and second frames supporting the blades. One end of a blade in a longitudinal direction thereof includes a first support rotatably supported by the first frame, and a second support rotatably supported by the second frame. The first support and the second support are disposed along a widthwise direction of the blade. Another end of the blade in the longitudinal direction thereof includes a third support rotatably supported by the first frame, and a fourth support rotatably supported by the second frame. The third support and the fourth support are disposed along the widthwise direction of the blade.

### CROSS REFERENCE TO RELATED APPLICATIONS

This application is based on and claims the benefits of priority of Japanese Patent Application No. 2016-070212 filed on Mar. 31, 2016, and Japanese Patent Application No. 2017-023047 filed on Feb. 10, 2017, the entire disclosure of which is incorporated herein by reference.

### TECHNICAL FIELD

The present disclosure relates to a shutter device for a vehicle and a manufacturing method of the shutter device.

### BACKGROUND ART

Air is introduced into an engine room on the front side of a vehicle from a front grill. The air is used for heat radiation of a radiator, heat radiation of a condenser of a vehicle air conditioner, and the like. However, the air being introduced may cool the engine room too much and reduce the fuel efficiency of the vehicle on high speed travel or in winter, for example. It is also preferable in some cases to temporarily prevent or reduce the introduction of air into the engine room in order to reduce the aerodynamic drag of the vehicle.

Accordingly, a shutter device for temporarily preventing or reducing the flow of air introduced into the engine room is provided on the front side of the vehicle in some cases. For example, a shutter device disclosed in Patent Literature 1 includes a plurality of blades (blade members) each having a plate shape with a main surface having a substantially rectangular shape. The air passes through a gap formed between the blades and flows into the engine room. When the shutter device is actuated to cause the blades to rotate about its support shafts, ends of the blades in the widthwise direction thereof come into contact with each other to close the aforementioned gap. As a result, the inflow of air into the engine room is prevented.

### PRIOR ART LITERATURE

### Patent Literature

Patent Literature 1: JP 2007-001503 A

### SUMMARY

The shutter device as described above is disposed at a position in the vicinity of the front grill or a position in the vicinity of the radiator, for example, in the internal space of the vehicle. Considering that the internal space of the vehicle is limited, the dimension of the shutter device in the longitudinal direction of the vehicle is desirably as small as possible. In other words, the shutter device is desirably made as thin as possible.

On the occurrence of a vehicle collision, the shutter device possibly comes into contact with another component such as the radiator so that not only the shutter device but also the other component can be damaged. The shutter device is thus desirably made thin in terms of preventing such damage to the other component as well.

In order to make the shutter device thin, the dimension (i.e. the width) of the blade in the widthwise direction may be reduced and at the same time the number of blades provided in the shutter device may be increased. However, a large number of narrow blades provided in the shutter device can reduce the rigidity of the entire shutter device excessively.

An object of the present disclosure is to provide a shutter device, the rigidity of which is not reduced excessively even with a decrease in the dimension of a blade in the widthwise direction, and a method for manufacturing the shutter device.

A shutter device according to the present disclosure is a shutter device for a vehicle and includes: blades that are a plurality of members each having a plate shape and being configured to rotate about a rotational axis along a longitudinal direction of each blade to switch between a state in which an air flow is interrupted by the blades and a state in which an air flow is not interrupted by the blades; a first frame that is a member supporting the blades; and a second frame that is a member supporting the blades and is movable relative to the first frame. One end of each of the blades in the longitudinal direction includes a first support rotatably supported by the first frame, and a second support rotatably supported by the second frame, and the first support and the second support are disposed along a widthwise direction of the blade. Another end of each of the blades in the longitudinal direction includes a third support rotatably supported by the first frame, and a fourth support supported by the second frame, and the third support and the fourth support are disposed along the widthwise direction of the blade.

In the shutter device configured as described above, all the blades are supported not by a single frame but by both the first frame and the second frame. In other words, the first frame and the second frame are bridged and connected by the plurality of blades. Therefore, the rigidity of the shutter device as a whole is not reduced excessively even when the dimensions of the blades in the widthwise direction are decreased.

A method of manufacturing a shutter device according to the present discloser is a method of manufacturing the shutter device having the above-described configuration. The method includes molding of all the blades, the first frame, and the second frame inside a molding die, and assembling of the blades, the first frame and the second frame by moving a part of the molding die such that each of the blades is supported by the first frame and the second frame.

Such a manufacturing method moves parts of the molding die to be able to complete at once the assembling of the plurality of blades to the first frame and the assembling of the plurality of blades to the second frame. Adopting such an in-mold assembly method can prevent an increase in manufacturing cost when the number of blades is increased.

The present disclosure provides the shutter device, the rigidity of which is not reduced excessively even with a decrease in the dimension of the blade in the widthwise direction, and the method for manufacturing the shutter device.

### BRIEF DESCRIPTION OF DRAWINGS

FIG. 1 is a view illustrating the overall configuration of a shutter device according to a first embodiment.

FIG. 2 is an enlarged view of area A in FIG. 1.

FIG. 3 is a view illustrating the shutter device that is closed.

FIG. 4 is a view schematically illustrating the shape of a blade.

FIG. 5 is a view illustrating a state in which the shutter device is disposed between a radiator and a condenser.

FIG. 6 is a view illustrating the shape of a support formed at an end of the blade.

FIG. 7 is an explanatory view of the configuration of a part where the blade is supported by a first frame and a second frame.

FIG. 8 is an explanatory view of the configuration of the part where the blade is supported by the first frame and the second frame.

FIG. 9 is a diagram illustrating a process of manufacturing the shutter device.

FIG. 10 is an explanatory view of a state of the shutter device inside a molding die.

FIG. 11 is a view illustrating the configuration of a shutter device according to a second embodiment.

FIG. 12 is a view illustrating a state of a blade when the shutter device is fully closed.

FIG. 13 is a view illustrating a state of the blade in a molding step.

FIG. 14 is a view illustrating the shape of a support formed at an end of the blade.

FIG. 15 is a view illustrating the configuration of a shutter device according to a third embodiment.

FIG. 16 is an exploded view illustrating the structure of area B in FIG. 15.

FIG. 17 is an exploded view illustrating the structure of area C in FIG. 15.

FIG. 18 is a view illustrating the configuration of a shutter unit including a plurality of the shutter devices in FIG. 15.

FIG. 19 is a view illustrating the configuration of a holding frame of the shutter unit.

FIG. 20 is an exploded view illustrating the structure of area D in FIG. 18.

FIG. 21 is an exploded view illustrating the structure of area E in FIG. 18.

FIG. 22 is an exploded view illustrating the structure of area F in FIG. 18.

FIG. 23 is an exploded view illustrating the structure of area G in FIG. 18.

FIG. 24 is an exploded view illustrating the structure of area G in FIG. 18.

### DETAILED DESCRIPTION

The present embodiment will now be described with reference to the drawings. In order to facilitate understanding of the description, the same component is denoted by the same reference numeral as much as possible in the drawings, and a redundant description will be omitted.

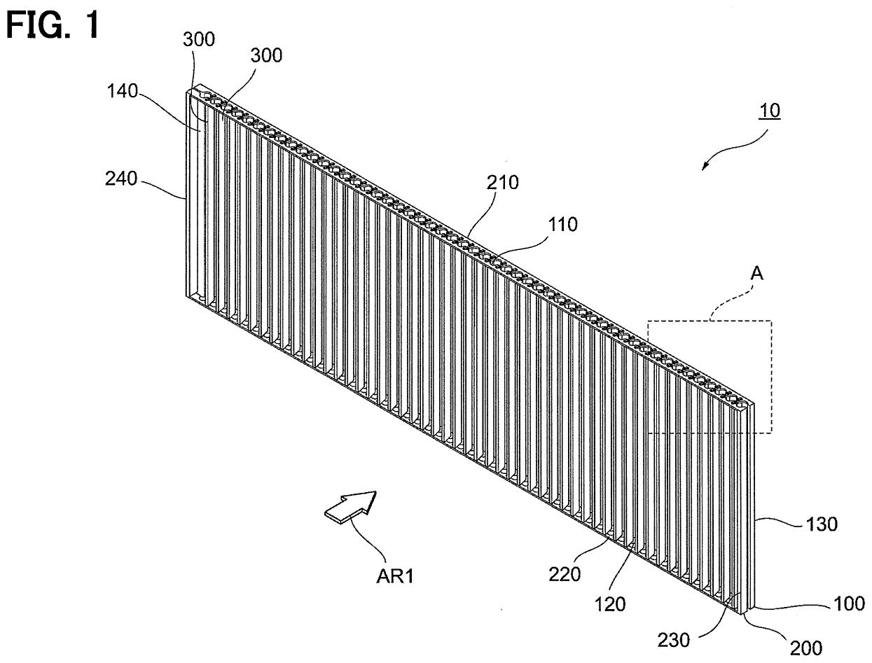

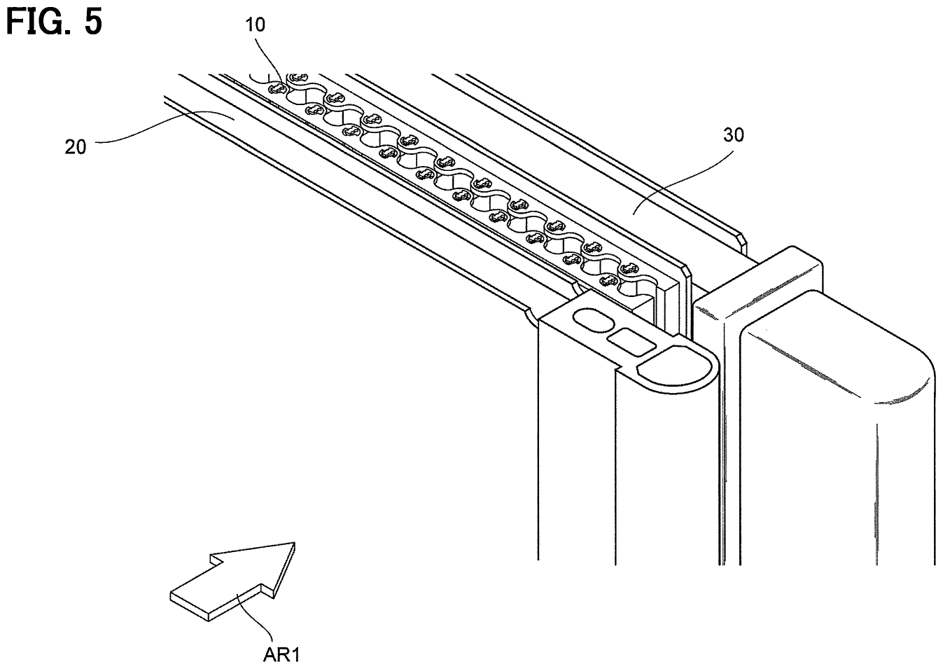

The configuration of a shutter device 10 according to a first embodiment will be described with reference to FIGS. 1 to 5. The shutter device 10 is a device for temporarily cutting off the flow of air flowing into an engine room from a front grill of a vehicle (not shown). As illustrated in FIG. 5, the shutter device 10 is disposed at a position between a condenser 20 and a radiator 30 on the front side of the vehicle.

The condenser 20 is a part of an air conditioner included in the vehicle. The condenser 20 is a heat exchanger that allows heat exchange between a refrigerant circulating in the refrigeration cycle and the air, thereby radiating heat from the refrigerant to the air. The radiator 30 is a heat exchanger that allows heat exchange between a coolant heated in the internal combustion engine of the vehicle and the air, thereby radiating heat from the coolant to the air. In FIGS. 1 and 5, arrow AR1 indicates the flow of air introduced from the front grill into the engine room.

The air being introduced may cool the engine room too much and reduce the fuel efficiency of the vehicle on high speed travel or in winter, for example. Moreover, it is preferable in some cases to temporarily prevent or reduce the introduction of air into the engine room in order to reduce the aerodynamic drag of the vehicle.

The shutter device 10 can switch between a state (hereinafter also referred to as a “closed state”) in which the flow of air flowing into the engine room is cut off and a state (hereinafter also referred to as an “open state”) in which the flow of air is not cut off. Such a switching operation of the shutter device 10 can temporarily prevent or reduce the inflow of air into the engine room.

The arrangement illustrated in FIG. 5 is merely an example, and thus the shutter device 10 may be provided at a different position. For example, the shutter device 10 may be disposed at a position slightly downstream of the front grill.

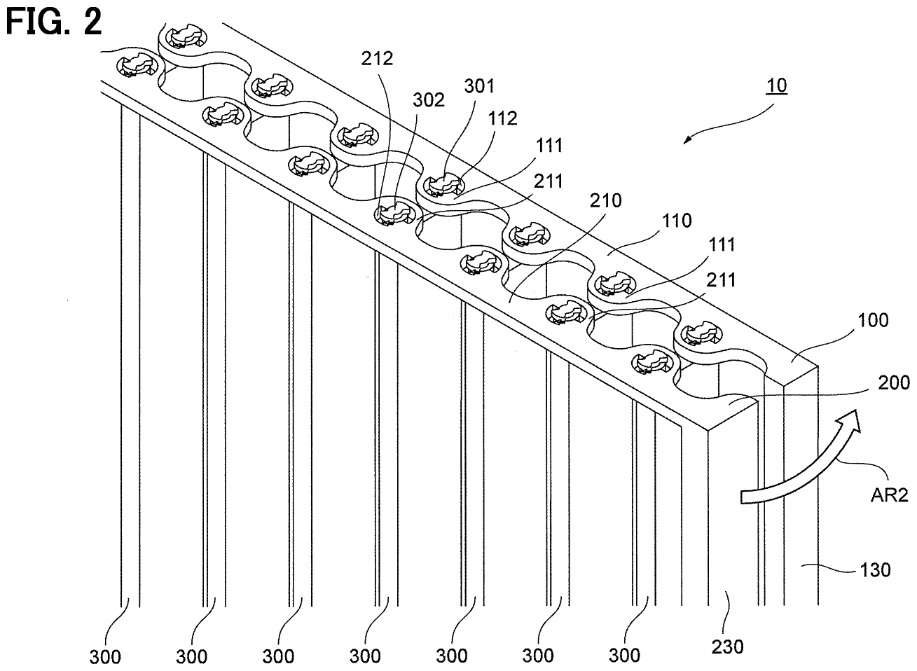

FIG. 1 illustrates the overall configuration of the shutter device 10 in the open state. FIG. 2 illustrates an enlarged view of area A in FIG. 1. As illustrated in both figures, the shutter device 10 includes a fixed frame 100, a movable frame 200, and blades 300.

The fixed frame 100 is a frame body formed into a rectangular shape overall, and is a member that rotatably supports the blades 300 to be described later. In the present embodiment, the fixed frame 100 is made of polyamide. Another resin or metal such as aluminum may be used as the material of the fixed frame 100. The fixed frame 100 corresponds to a “first frame” of the present embodiment.

The fixed frame 100 is fixed to the radiator or the condenser, for example. Alternatively, the fixed frame 100 may be directly fixed to the vehicle body. That is, the fixed frame may be indirectly fixed to the vehicle body by interposing another member therebetween, or may be directly fixed to the vehicle body. In other words, the fixed frame 100 need only be fixed to the vehicle body.

The fixed frame 100 includes an upper horizontal part 110, vertical parts 130 and 140, and a lower horizontal part 120. With the shutter device 10 being attached to the vehicle, the upper horizontal part 110 is a part corresponding to the upper side of the fixed frame 100 having the rectangular shape. As illustrated in FIG. 2, a plurality of protrusions 111 (fixed side protrusions) protruding toward the movable frame 200 described later is formed in the upper horizontal part 110. The protrusions 111 are arranged side by side at equal intervals along the longitudinal direction of the upper horizontal part 110.

An insertion hole 112 is formed in each protrusion 111. The insertion hole 112 is a through hole formed to pass through the protrusion 111 in the vertical direction. A first support 301 formed on the blade 300 is inserted into the insertion hole 112 from below. That is, the upper horizontal part 110 is a part of the fixed frame 100 that supports the first support 301.

The vertical part 130 is a part extending downward from one end of the upper horizontal part 110. The vertical part 140 is a part extending downward from the other end of the upper horizontal part 110. The vertical parts 130 and 140 are parts corresponding to the right side and the left side of the fixed frame 100 having the rectangular shape. The vertical parts 130 and 140 both connect the upper horizontal part 110 and the lower horizontal part 120.

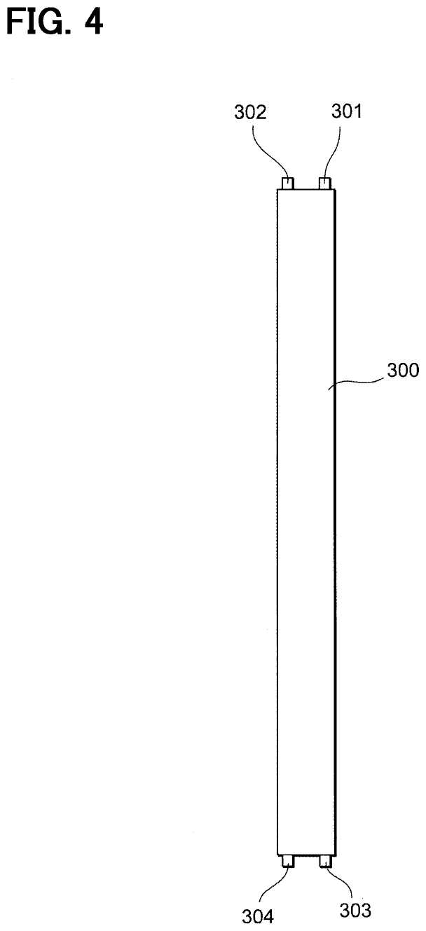

The lower horizontal part 120 is a part corresponding to the lower side of the fixed frame 100 having the rectangular shape. A lower end of the vertical part 130 is connected to one end side of the lower horizontal part 120, and a lower end of the vertical part 140 is connected to the other end side of the lower horizontal part 120. The shape of the lower horizontal part 120 is substantially the same as the shape of the upper horizontal part 110. Protrusions (details are not shown) having the same shape as the protrusions 111 of the upper horizontal part 110 are formed in the lower horizontal part 120. An insertion hole (details are not shown) having the same shape as the insertion hole 112 of the upper horizontal part 110 is formed in each protrusion. Moreover, a third support 303 (see FIG. 4) formed at the lower end of the blade 300 is inserted into the insertion hole from above. That is, the lower horizontal part 120 is a part of the fixed frame 100 that supports the third support 303.

The shape of a part of the lower horizontal part 120 that supports the blade 300 from below is identical to vertical inversion of the shape of the upper horizontal part 110 illustrated in FIG. 2. Thus, in the following description, the protrusion (fixed side protrusion) formed in the lower horizontal part 120 will be denoted as the “protrusion 111” as with the case of the upper horizontal part 110. Moreover, the insertion hole formed in the protrusion 111 of the lower horizontal part 120 will be denoted as the “insertion hole 112” as with the case of the upper horizontal part 110.

Similar to the fixed frame 100, the movable frame 200 is a frame body formed into a rectangular shape overall, and is a member that rotatably supports the blades 300. The movable frame 200 is formed to have substantially the same shape as the fixed frame 100, and is disposed to face the fixed frame 100 with the blades 300 interposed therebetween.

In the present embodiment, the movable frame 200 is made of the same material (polyamide) as the fixed frame 100. Another resin or metal such as aluminum may be used as the material of the movable frame 200. Alternatively, a material different from the material of the fixed frame 100 may be used as the material of the movable frame 200. The movable frame 200 corresponds to a “second frame” of the present embodiment.

The movable frame 200 is not fixed to the vehicle body unlike the fixed frame 100. The movable frame 200 is rotatably connected to a second support 302 (to be described) of each blade 300. The movable frame 200 can thus be moved relative to the fixed frame 100. As described later, opening and closing of the shutter device 10 is switched by the movement of the movable frame 200.

The movable frame 200 includes an upper horizontal part 210, vertical parts 230 and 240, and a lower horizontal part 220. With the shutter device 10 being attached to the vehicle, the upper horizontal part 210 is a part corresponding to the upper side of the movable frame 200 having the rectangular shape. The length of the movable frame 200 is the same as the length of the fixed frame 100.

As illustrated in FIG. 2, a plurality of protrusions 211 (movable side protrusions) protruding toward the fixed frame 100 is formed in the upper horizontal part 210. The protrusions 211 are arranged side by side at equal intervals along the longitudinal direction of the upper horizontal part 210. When the shutter device 10 is in the open state as illustrated in FIG. 2, the protrusions 211 are positioned to face the protrusions 111 along the direction of the air flow (along arrow AR1).

An insertion hole 212 is formed in each protrusion 211. The insertion hole 212 is a through hole formed to pass through the protrusion 211 in the vertical direction. The second support 302 formed on the blade 300 is inserted into the insertion hole 212 from below. That is, the upper horizontal part 210 is a part of the movable frame 200 that supports the second support 302.

The vertical part 230 is a part extending downward from one end of the upper horizontal part 210. The vertical part 240 is a part extending downward from the other end of the upper horizontal part 210. The vertical parts 230 and 240 are parts corresponding to the right side and the left side of the movable frame 200 having the rectangular shape. The vertical parts 230 and 240 both connect the upper horizontal part 210 and the lower horizontal part 220. The lengths of the vertical parts 230 and 240 are the same as the lengths of the vertical parts 130 and 140.

The lower horizontal part 220 is a part corresponding to the lower side of the movable frame 200 having the rectangular shape. A lower end of the vertical part 230 is connected to one end side of the lower horizontal part 220, and a lower end of the vertical part 240 is connected to the other end side of the lower horizontal part 220. The shape of the lower horizontal part 220 is substantially the same as the shape of the upper horizontal part 210. Protrusions (details are not shown) having the same shape as the protrusions 211 of the upper horizontal part 210 are formed in the lower horizontal part 220. An insertion hole (details are not shown) having the same shape as the insertion hole 212 of the upper horizontal part 210 is formed in each protrusion. Moreover, a fourth support 304 (see FIG. 4) formed at the lower end of the blade 300 is inserted into the insertion hole from above. That is, the lower horizontal part 220 is a part of the movable frame 200 that supports the fourth support 304.

The shape of a part of the lower horizontal part 220 that supports the blade 300 from below is identical to vertical inversion of the shape of the upper horizontal part 210 illustrated in FIG. 2. Thus, in the following description, the protrusion (movable side protrusion) formed in the lower horizontal part 220 will be denoted as the “protrusion 211” as with the case of the upper horizontal part 210. Moreover, the insertion hole formed in the protrusion 211 of the lower horizontal part 220 will be denoted as the “insertion hole 212” as with the case of the upper horizontal part 210. When the shutter device 10 is in the open state as illustrated in FIG. 2, the protrusions 211 formed in the lower horizontal part 220 are positioned to face the protrusions 111 of the lower horizontal part 120 along the direction of the air flow (along arrow AR1).

The blade 300 is a member having a plate shape with a main surface thereof formed into a substantially rectangular shape. A plurality of the blades 300 is provided in the shutter device 10. In the present embodiment, the blades 300 are made of the same material (polyamide) as the fixed frame 100 and the like. Another resin or metal such as aluminum may be used as the material of the blades 300. Alternatively, a material different from the material of the fixed frame 100 and the movable frame 200 may be used as the material of the blades 300. Although the longitudinal directions of the blades 300 are aligned with the vertical direction in the present embodiment, the longitudinal directions of the blades 300 may be aligned with the left-right direction (horizontal direction). The effect of the shutter device 10 described below does not change regardless of the direction with which the longitudinal directions of the blades 300 are aligned.

The shapes of the blades 300 are identical to one another. The blades 300 are supported by the fixed frame 100 and the movable frame 200 while the longitudinal directions of the blades are aligned with the longitudinal direction of the vertical part 130 and the like.

FIG. 4 is a view schematically illustrating the blade 300 as seen from a direction perpendicular to the main surface thereof. As illustrated in FIG. 4, the first support 301 and the second support 302 are formed on one end side (an upper end side) of the blade 300 in the longitudinal direction. The third support 303 and the fourth support 304 are formed on the other end side (a lower end side) of the blade 300 in the longitudinal direction.

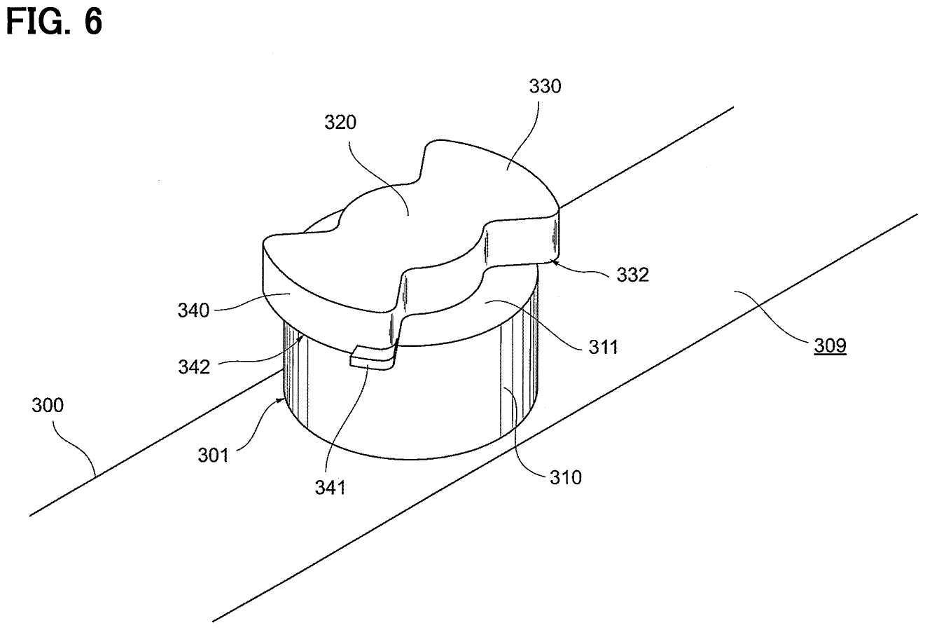

The first support 301 and the second support 302 are projections formed to protrude upward from an upper end surface of the blade 300. The shapes of the first support 301 and the second support 302 are simplified in FIG. 4. Specific shapes of the first support 301 and the like will be described later with reference to FIG. 6 and the like.

The first support 301 and the second support 302 are formed side by side along the widthwise direction (left-right direction in FIG. 4) of the blade 300. As described above, the first support 301 is a part that is inserted into the insertion hole 112 of the upper horizontal part 110 from below. The blade 300 is supported at the first support 301 to be able to rotate with respect to the fixed frame 100. The second support 302 is a part that is inserted into the insertion hole 212 of the upper horizontal part 210 from below. The blade 300 is supported at the second support 302 to be able to rotate with respect to the movable frame 200.

The third support 303 and the fourth support 304 are projections formed to protrude downward from a lower end surface of the blade 300. The shapes of the third support 303 and the fourth support 304 are also simplified in FIG. 4. The third support 303 and the fourth support 304 each have a specific shape that is identical to a shape obtained by vertically inverting the shape of the first support 301 to be described later.

The third support 303 and the fourth support 304 are formed side by side along the widthwise direction (left-right direction in FIG. 4) of the blade 300. The third support 303 is formed at a position directly below the first support 301 along the longitudinal direction (vertical direction in

FIG. 4) of the blade 300. A central axis of the third support 303 thus coincides with a central axis of the first support 301. The fourth support 304 is formed at a position directly below the second support 302 along the longitudinal direction of the blade 300. A central axis of the fourth support 304 thus coincides with a central axis of the second support 302.

As described above, the third support 303 is a part that is inserted into the insertion hole 112 of the lower horizontal part 120 from above. The blade 300 is supported at the third support 303 to be able to rotate with respect to the fixed frame 100. The fourth support 304 is a part that is inserted into the insertion hole 212 of the lower horizontal part 220 from above. The blade 300 is supported at the fourth support 304 to be able to rotate with respect to the movable frame 200.

In the open state illustrated in FIG. 2, a direction normal to each blade 300 is parallel to the longitudinal direction of the upper horizontal part 110 and the like. This maximizes a gap formed between the blades 300 adjacent to each other, or a cross sectional area of a passage through which the air passes.

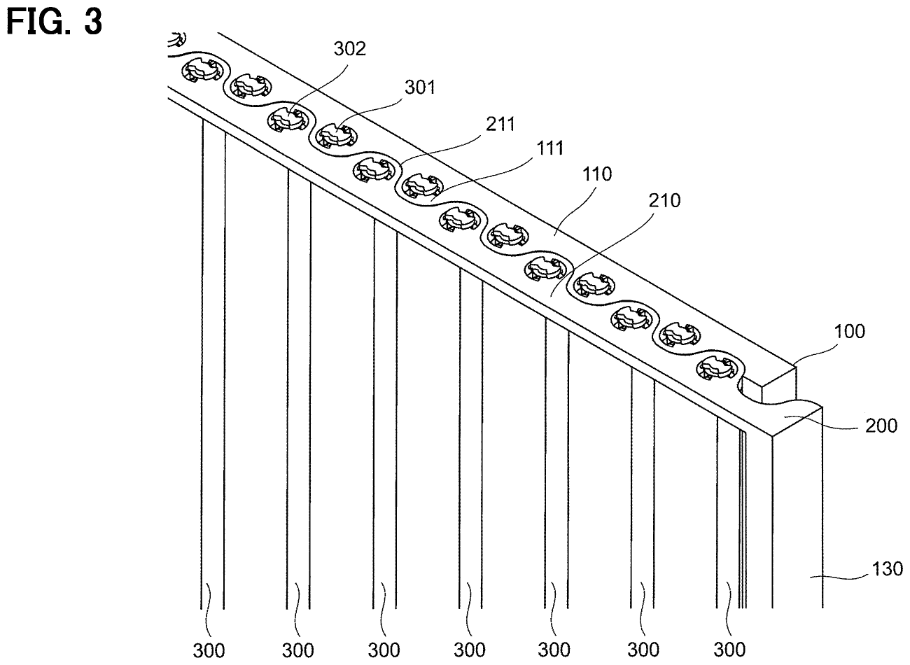

When the movable frame 200 moves in the direction of arrow AR2 from the state of FIG. 2, the normal directions of the blades 300 change while the blades remain parallel with each other. This gradually decreases the cross sectional area of the passage through which the air passes. Eventually, ends in the widthwise direction (that is, areas near the long sides) of the blades 300 adjacent to each other are brought into contact with each other as illustrated in FIG. 3. At this time, the blades 300 adjacent to each other form zero gap therebetween and zero cross sectional area of the passage through which the air passes, whereby the shutter device 10 is in the closed state.

Each of the blades 300 thus functions as a member that switches between a state in which the air flow is cut off (the closed state in FIG. 3) and a state in which the air flow is not cut off (the open state in FIG. 2) by rotating about a rotational axis along the longitudinal direction of the blade. In the present embodiment, the central axis of each of the first support 301 and the third support 303 corresponds to the “rotational axis”.

The opening and closing operation of the shutter device 10 is performed when an actuator (not shown) provided in the vehicle moves the movable frame 200 (that is, moves the movable frame 200 relative to the fixed frame 100). The flow rate of the air flowing into the engine room is adjusted as a result.

In the shutter device 10 configured as described above, all the blades 300 are supported not by a single frame but by both the fixed frame 100 and the movable frame 200. In other words, the fixed frame 100 and the movable frame 200 are bridged and connected by the plurality of blades 300. Therefore, the rigidity of the shutter device 10 as a whole is not reduced excessively even when the dimensions of the blades 300 in the widthwise direction are decreased.

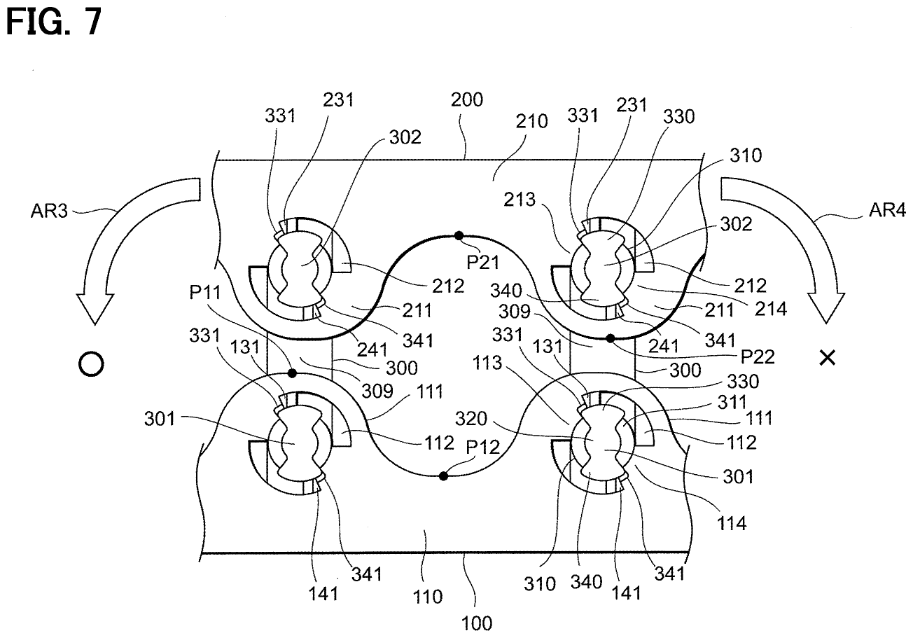

A specific configuration of a part where the first support 301 is supported by the upper horizontal part 110 will be described with reference to FIGS. 6, 7, and 14. FIG. 6 is an enlarged perspective view of the shape of the first support 301 and the vicinity of the first support 301. FIG. 7 is a view of a part (in the vicinity of the first support 301) of the shutter device 10 in the open state, as viewed from above.

As illustrated in FIG. 6, the first support 301 includes a columnar part 310 and a stopper 320. The columnar part 310 is a part formed to extend upward (along the longitudinal direction of the blade 300) from an upper end surface 309 of the blade 300. The columnar part 310 has a columnar shape whose central axis is perpendicular to the upper end surface 309.

The stopper 320 is a part formed to extend further upward from an upper surface 311 of the columnar part 310. The stopper 320 has a pair of protrusions 330 and 340. The protrusions 330 and 340 are formed to extend toward both sides of the blade 300 in the widthwise direction from a part having a substantially columnar shape formed at the center of the stopper 320. Each of the protrusions 330 and 340 protrudes radially outward beyond the edge of the upper end surface 309 having a circular shape. A lower surface 332 of the protrusion 330 thus faces the upper end surface 309 of the blade 300. Similarly, the lower surface 332 of the protrusion 330 faces the upper end surface 309 of the blade 300.

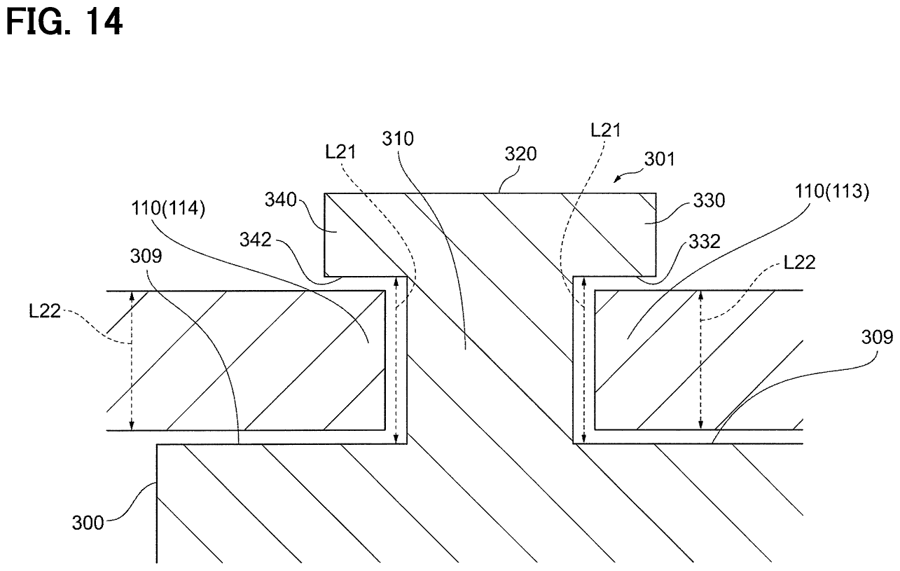

As illustrated in FIG. 14, the distance (L21) from the lower surface 332 to the upper end surface 309 is slightly larger than the thickness of the upper horizontal part 110, specifically, the thickness (L22) of a protrusion 113 which is a part facing the upper end surface 309. Similarly, the distance (L21) from the lower surface 342 to the upper end surface 309 is slightly larger than the thickness of the upper horizontal part 110, specifically, the thickness (L22) of a protrusion 114 which is a part facing the upper end surface 309.

As illustrated in FIG. 6, a projection 341 is formed at a lower end of the side surface of a tip of the protrusion 340. The projection 341 is formed at a right end of the tip of the protrusion 340 when the tip is viewed from the front. A lower end surface of the projection 341 is flush with the lower surface 342.

A projection 331 is formed at a lower end of the side surface of a tip of the protrusion 330 (not shown in FIG. 6. See FIG. 7). The projection 331 is formed at a right end of the tip of the protrusion 330 when the tip is viewed from the front. That is, the projections 331 and 341 are formed at positions symmetrical with each other about the central axis of the columnar part 310. A lower end surface of the projection 331 is flush with the lower surface 332.

The insertion hole 112 formed in the protrusion 111 is a substantially circular through hole as illustrated in FIG. 7, where two opposing parts of the edge of the insertion hole protrude toward the first support 301. The two protruding parts of the edge of the insertion hole 112 are indicated as protrusions 113 and 114 in FIG. 7. A tip of the protrusion 113 and a tip of the protrusion 114 support the columnar part 310 from the side surface thereof.

An upper surface of the protrusion 113 formed in the fixed frame 100 is in contact with the lower surface 332 of the protrusion 330 formed on the first support 301. A lower surface of the protrusion 113 formed in the fixed frame 100 is in contact with the upper end surface 309 of the blade 300. Similarly, an upper surface of the protrusion 114 formed in the fixed frame 100 is in contact with the lower surface 342 of the protrusion 340 formed on the first support 301. A lower surface of the protrusion 114 formed in the fixed frame 100 is in contact with the upper end surface 309 of the blade 300.

The above state is maintained at all times while the movable frame 200 moves in the direction of arrow AR3 to be in the closed state from the open state illustrated in FIG. 7. Thus, the blade 300 supported by the fixed frame 100 cannot be removed from the fixed frame 100 by moving the blade downward.

A projection 131 projecting upward is formed on the upper surface of the protrusion 113 formed in the fixed frame 100. The projection 131 is formed at a position to be in contact with the projection 331 formed on the first support 301 from the side thereof (the right side in FIG. 7) when the shutter device 10 is in the open state as in FIG. 7. A projection 141 projecting upward is formed on the upper surface of the protrusion 114 formed in the fixed frame 100. The projection 141 is formed at a position to be in contact with the projection 341 formed on the first support 301 from the side thereof (the left side in FIG. 7) when the shutter device 10 is in the open state as in FIG. 7.

Due to the contact between the projection 131 and the projection 331 and the contact between the projection 141 and the projection 341, the movable frame 200 cannot be moved in the direction of arrow AR4 from the state of FIG. 7. That is, after the rotational angles of the blades 300 are changed from the closed state illustrated in FIG. 3 to the state illustrated in FIG. 7 (the state in which the shutter device 10 is fully opened), the rotational angles cannot be changed any further in the same direction (in the direction of arrow AR4). The projections 131, 331, 141, and 341 function as stopper mechanisms for preventing an excessive change in the rotational angles of the blades 300 as described above.

In the present embodiment, the shape of the second support 302 is identical to the shape of the first support 301 illustrated in FIGS. 6, 7, and 14. Thus, in the following description, a columnar part formed on the lower side of the second support 302 will be denoted as the “columnar part 310” as with the case of the first support 301. A pair of protrusions formed in the second support 302 will be denoted as the “protrusion 330” and the “protrusion 340” as with the case of the first support 301. A pair of projections formed in the second support 302 will be denoted as the “projection 331” and the “projection 341” as with the case of the first support 301.

As illustrated in FIG. 7, the shape of the insertion hole 212 formed in the movable frame 200 is identical to the shape of the insertion hole 112 formed in the fixed frame 100. A part of the edge of the insertion hole 212 corresponding to the protrusion 113 of the insertion hole 112 will be hereinafter denoted as a “protrusion 213”. A part of the edge of the insertion hole 212 corresponding to the protrusion 114 of the insertion hole 112 will be hereinafter denoted as a “protrusion 214”.

An upper surface of the protrusion 213 formed in the movable frame 200 is in contact with the lower surface of the protrusion 330 formed on the second support 302. A lower surface of the protrusion 213 formed in the movable frame 200 is in contact with the upper end surface 309 of the blade 300. Similarly, an upper surface of the protrusion 214 formed in the movable frame 200 is in contact with the lower surface of the protrusion 340 formed on the second support 302. A lower surface of the protrusion 214 formed in the movable frame 200 is in contact with the upper end surface 309 of the blade 300.

The above state is maintained at all times while the movable frame 200 moves in the direction of arrow AR3 to be in the closed state from the open state illustrated in FIG. 7. Thus, the blade 300 supported by the movable frame 200 cannot be removed from the movable frame 200 by moving the blade downward.

A projection 231 projecting upward is formed on the upper surface of the protrusion 213 formed in the movable frame 200. The projection 231 is formed at a position to be in contact with the projection 331 formed on the second support 302 from the side thereof (the right side in FIG. 7) when the shutter device 10 is in the open state as in FIG. 7. A projection 241 projecting upward is formed on the upper surface of the protrusion 214 formed in the movable frame 200. The projection 241 is formed at a position to be in contact with the projection 341 formed on the second support 302 from the side thereof (the left side in FIG. 7) when the shutter device 10 is in the open state as in FIG. 7. The contact between the projection 231 and the projection 331 of the second support 302 and the contact between the projection 241 and the projection 341 of the second support 302 also make the movable frame 200 immovable in the direction of arrow AR4 from the state of FIG. 7. The projection 231, the projection 331 of the second support 302, the projection 241, and the projection 341 of the second support 302 function as stopper mechanisms for preventing an excessive change in the rotational angles of the blades 300 as described above.

The projection formed as the stopper mechanism may be formed on all the supports (the first support 301A, the second support 302A, the third support 303A, and the fourth support 304A) as in the present embodiment or may be formed only on some of the supports. Alternatively, the projections 331 and 341 may be formed only on some of the blades 300. That is, the blade 300 on which the projection 331 and the like are not formed at all may be mixed among the blades.

As described above, the shape of a part of the lower horizontal part 120 that supports the blade 300 from below is identical to vertical inversion of the shape of the upper horizontal part 110 illustrated in FIGS. 2 and 7. The shape of a part of the lower horizontal part 220 that supports the blade 300 from below is identical to vertical inversion of the shape of the upper horizontal part 210 illustrated in FIGS. 2 and 7. Moreover, the shapes of the third support 303 and the fourth support 304 are identical to vertical inversions of the shapes of the first support 301 and the second support 302 illustrated in FIGS. 6 and 7.

As a result, the structure of a part of the third support 303 supported by the fixed frame 100 is identical to the structure of a part of the first support 301 supported by the fixed frame 100. The structure of a part of the fourth support 304 supported by the movable frame 200 is identical to the structure of a part of the third support 303 supported by the movable frame 200. Thus, specific illustration and description of these structures will be omitted.

In FIG. 7, a point at the tip of the protrusion 111 (fixed side protrusion) is denoted as point P11. A point at the bottom of a recess formed between the adjacent protrusions 111 is denoted as point P12. Similarly, a point at the tip of the protrusion 211 (movable side protrusion) is denoted as point P22. A point at the bottom of a recess formed between the adjacent protrusions 211 is denoted as point P21.

When the movable frame 200 moves in the direction of arrow AR3 to be in the fully closed state (the state in FIG. 2) from the state illustrated in FIG. 7, point P21 is brought into contact with point P11, and point P22 is brought into contact with point P12. Such a configuration reduces the thickness of the shutter device 10.

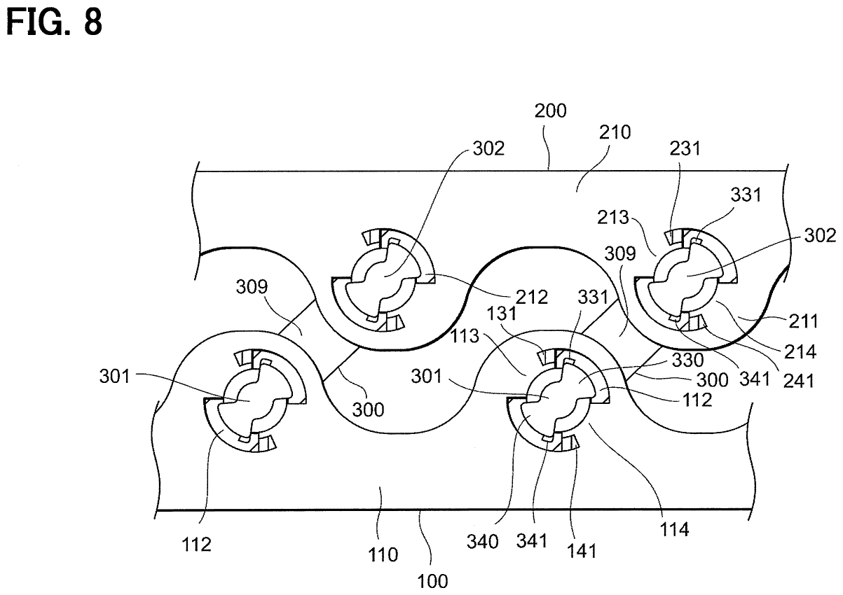

When a relatively large force is applied to the movable frame 200 in the direction of arrow AR4 from the state illustrated in FIG. 7, the projection 331 goes over the projection 131 (the same applies to the other projections 341 and the like), thereby resulting in a state illustrated in FIG. 8.

In the state of FIG. 8, the protrusion 113 of the fixed frame 100 does not lie beneath (or on the back side of the page relative to) the protrusion 330 of the first support 301. The protrusion 114 of the fixed frame 100 does not lie beneath the protrusion 340 of the first support 301.

Likewise, in the state of FIG. 8, the protrusion 213 of the movable frame 200 does not lie beneath the protrusion 330 of the second support 302. The protrusion 214 of the movable frame 200 does not lie beneath the protrusion 340 of the second support 302.

Accordingly, in the state of FIG. 8, the first support 301 and the second support 302 can be removed from the fixed frame 100 and the movable frame 200 by moving the blade 300 downward. Similarly, the third support 303 and the fourth support 304 can be removed from the fixed frame 100 and the movable frame 200 by moving the blade 300 upward.

The rotational angle of each blade 300 in the state of FIG. 8 will be hereinafter also referred to as an “insertion angle”. When the rotational angle of the blade 300 is set at the insertion angle, the blade 300 is detachable from both the fixed frame 100 and the movable frame 200.

On the other hand, when the rotational angle of the blade 300 is set at an angle different from the insertion angle as illustrated in FIGS. 2, 7, and the like, the blade 300 is undetachable from both the fixed frame 100 and the movable frame 200.

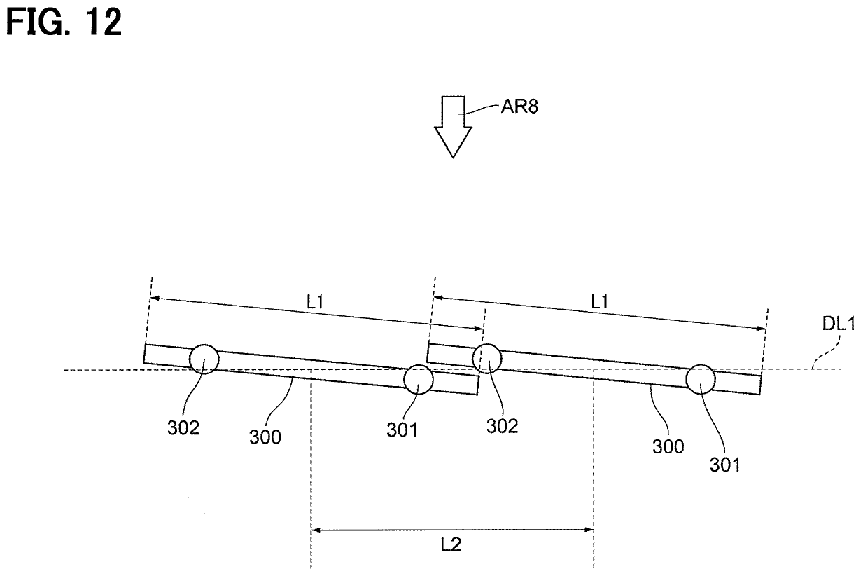

FIG. 12 schematically illustrates the state of the blades 300 when the shutter device 10 is fully closed. FIG. 12 is a view of two of the blades 300 adjacent to each other as seen along the longitudinal directions thereof. The length in the widthwise direction of the blade 300 is denoted as L1 in FIG. 12. The distance between centers of the blades 300 adjacent to each other is denoted as L2. The distance L2 corresponds to the distance between the blades 300 adjacent to each other when the shutter device 10 is fully opened. In the present embodiment, the length L1 is longer than the distance L2.

As a result, when viewed along the air flow direction (arrow AR8), the ends of the blades 300 in the widthwise direction overlap with each other in the state in which the shutter device 10 is fully closed as in FIG. 12. Thus, the flow of air passing through the shutter device 10 is surely cut off.

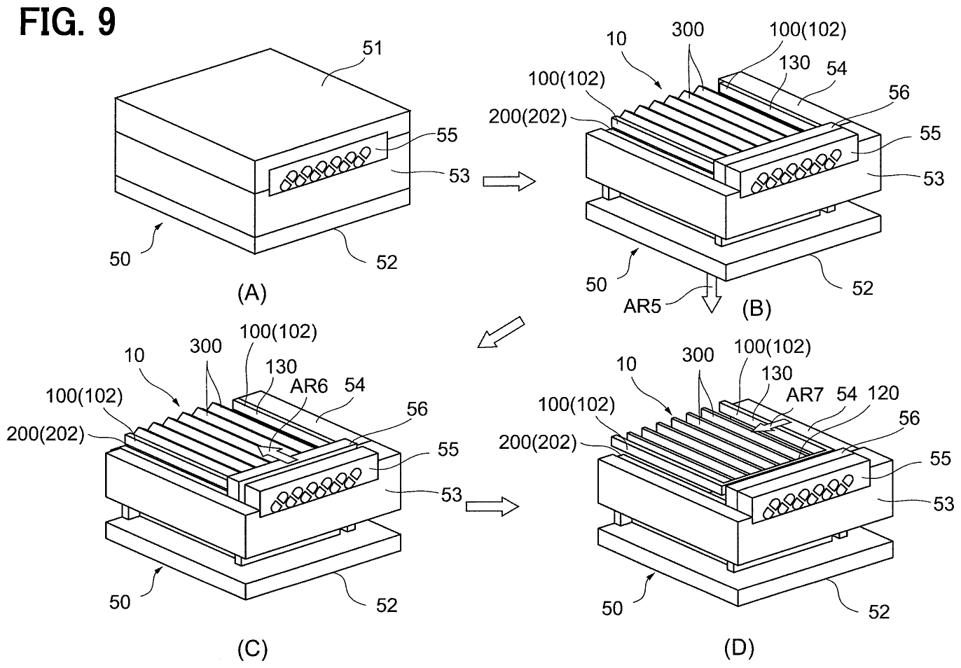

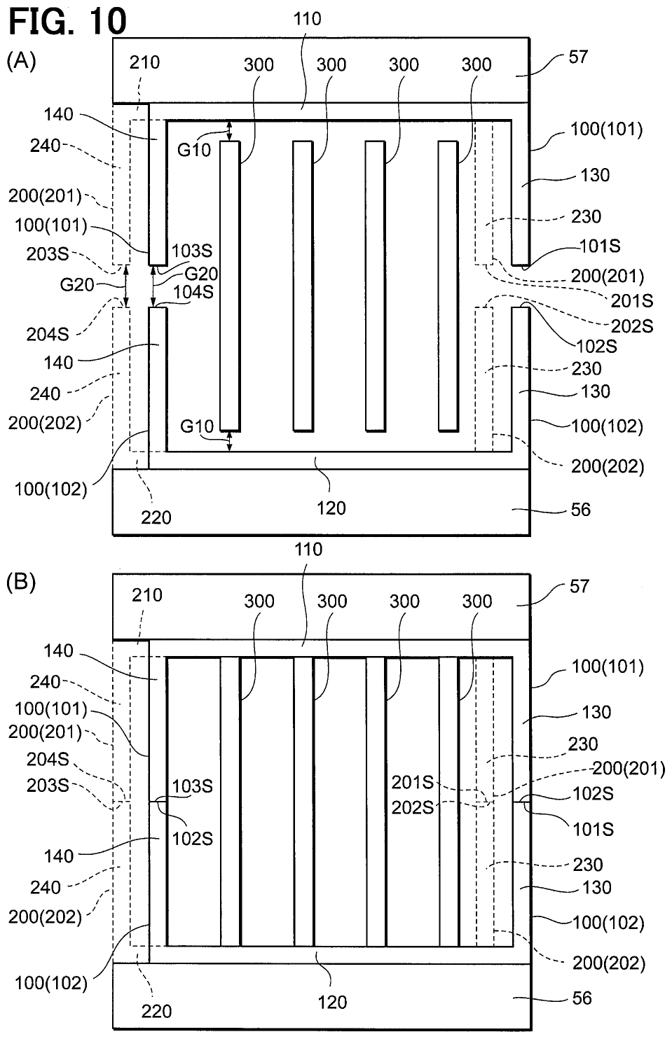

A method of manufacturing the shutter device 10 will be described with reference to FIG. 9. In the present embodiment, the components (the fixed frame 100, the movable frame 200, and the blades 300) making up the shutter device 10 are all formed by resin injection molding. Injection molding is performed by using a molding die 50. The molding die 50 is the assembly of a plurality of die members including an upper die 51, a first lower die 52, a second lower die 53, a first slide die 54, a second slide die 55, a third slide die 56, and a fourth slide die 57 (not shown in FIG. 9; see FIG. 10). FIG. 9 illustrates not the entire molding die 50 but only a part of the molding die 50. Specifically, only parts that form a lower side of the shutter device 10 are shown.

FIG. 9(A) illustrates a state in which injection molding of the shutter device 10 is performed inside the molding die 50 put together. At this time, the fixed frame 100, the movable frame 200, and the blades 300 are molded all at once inside the molding die 50. That is, FIG. 9(A) illustrates a state in which a molding step of the manufacturing process of the shutter device 10 is performed.

FIG. 10(A) schematically illustrates a top view of the arrangement of the components including the fixed frame 100, the movable frame 200, and the blades 300 inside FIG. 9(A). FIG. 10A indicates the movable frame 200 with dotted lines and the other parts with solid lines. FIG. 10 also schematically illustrates parts of the molding die 50 (the third slide die 56 and the fourth slide die 57).

As illustrated in FIG. 10(A), the fixed frame 100 is divided into two parts (an upper frame 101 and a lower frame 102) when the molding step is performed. The upper frame 101 is a part including the upper horizontal part 110 of the fixed frame 100 and corresponding to an upper side when in use. The lower frame 102 is a part including the lower horizontal part 120 of the fixed frame 100 and corresponding to a lower side when in use. In the molding step, the upper frame 101 and the lower frame 102 are separated from each other along the longitudinal direction of the vertical part 130 (the vertical direction in FIG. 10(A)).

Likewise, the movable frame 200 is divided into two parts (an upper frame 201 and a lower frame 202) when the molding step is performed. The upper frame 201 is a part including the upper horizontal part 210 of the movable frame 200 and corresponding to an upper side when in use. The lower frame 202 is a part including the lower horizontal part 220 of the movable frame 200 and corresponding to a lower side when in use. In the molding step, the upper frame 201 and the lower frame 202 are separated from each other along the longitudinal direction of the vertical part 230 (the vertical direction in FIG. 10(A)).

In FIG. 10, an end face of the vertical part 130 of the upper frame 101 is denoted as an end face 101S, and an end face of the vertical part 140 of the upper frame 101 is denoted as an end face 103S. An end face of the vertical part 130 of the lower frame 102 is denoted as an end face 102S, and an end face of the vertical part 140 of the lower frame 102 is denoted as an end face 104S.

Likewise, an end face of the vertical part 230 of the upper frame 201 is denoted as an end face 201S, and an end face of the vertical part 240 of the upper frame 201 is denoted as an end face 203S. An end face of the vertical part 230 of the lower frame 202 is denoted as an end face 202S, and an end face of the vertical part 240 of the lower frame 202 is denoted as an end face 204S.

When the molding step is performed, the end face 101S faces the end face 102S, and the end face 103S faces the end face 104S. The end face 201S faces the end face 202S, and the end face 203S faces the end face 204S.

The distance between the end face 101S and the end face 102S, the distance between the end face 103S and the end face 104S, the distance between the end face 201S and the end face 202S, and the distance between the end face 203S and the end face 204S are all equal to one another. The distance is denoted as G20 in FIG. 10.

The distance between the end face (the upper end surface 309 in

FIG. 6) of the blade 300 and the upper horizontal part 110, the distance between the end face of the blade 300 and the lower horizontal part 120, the distance between the end face of the blade 300 and the upper horizontal part 210, and the distance between the end face of the blade 300 and the lower horizontal part 220 are all equal to one another. The distance is denoted as G10 in FIG. 10. The distance G20 is twice the distance G10 in the present embodiment.

When the molding step is performed, the fixed frame 100 and the movable frame 200 are in the positional relationship as illustrated in FIG. 8. That is, the movable frame 200 is offset with respect to the fixed frame 100 such that the protrusion 111 of the fixed frame 100 and the protrusion 211 of the movable frame 200 do not overlap in the vertical direction. In FIG. 10(A), the fixed frame 100 arranged on the upper side is offset to the right with respect to the movable frame 200 arranged on the lower side.

The blades 300 are molded while being arranged side by side between the upper frame 101 and the lower frame 102 and between the upper frame 201 and the lower frame 202. The blades 300 at this time are arranged in the state illustrated in FIG. 8. Specifically, the normal direction of the main surface of each of the blades 300 is inclined 45 degrees with respect to the longitudinal direction (the left-right direction in FIG. 8) of the upper horizontal part 110 and the like. In other words, the rotational angle of each of the blades 300 is set at the “insertion angle” described above.

When viewed along the longitudinal direction of the blades 300, the first support 301 overlaps the insertion hole 112 of the upper horizontal part 110, and the second support 302 overlaps the insertion hole 212 of the upper horizontal part 210. Likewise, the third support 303 overlaps the insertion hole 112 of the lower horizontal part 120, and the fourth support 304 overlaps the insertion hole 212 of the lower horizontal part 220.

Note that the first support 301 is not inserted through the insertion hole 112. The same applies to the second support 302, the third support 303, and the fourth support 304. Thus, the fixed frame 100 and the blades 300 do not overlap when viewed from above as illustrated in FIG. 10(A). Likewise, the movable frame 200 and the blades 300 do not overlap.

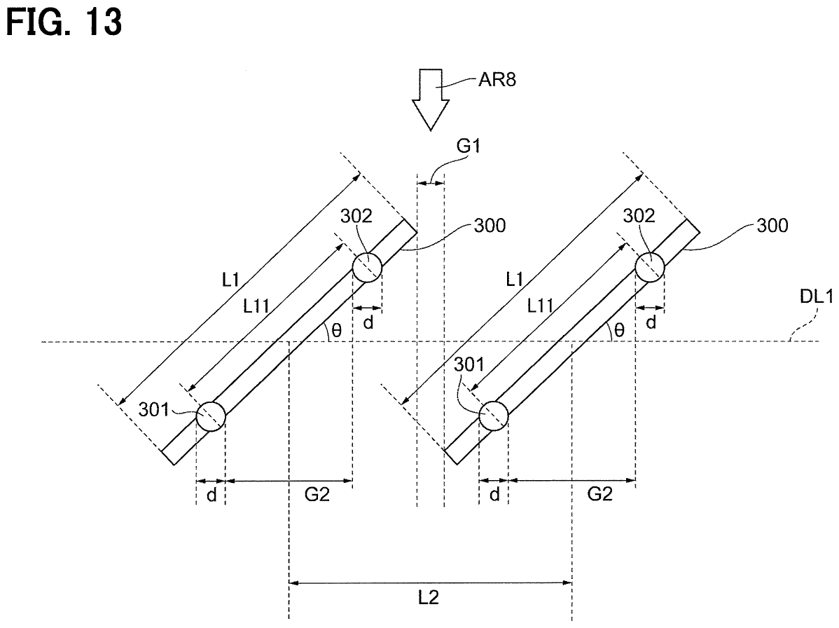

FIG. 13 schematically illustrates the state of the blades 300 in the molding step. FIG. 13 is a view of two of the blades 300 adjacent to each other as seen along the longitudinal directions thereof. Arrow AR8 in FIG. 13 indicates the direction perpendicular to both the longitudinal direction of the blades 300 (the depth direction of the page in FIG. 13) and the direction of arrangement of the plurality of blades 300 (the direction of extension of dotted line DL1 in FIG. 13). That is, arrow AR8 indicates the same direction as arrow AR8 indicating the air flow direction in FIG. 12. The insertion angle is denoted as “θ” in FIG. 13.

The plane indicated by dotted line DL1 in FIG. 13 is parallel to a boundary surface (that is, a split surface) between the upper die 51 and the parts therebelow (the second lower die 53 and the first slide die 54) of the molding die 50. Arrow AR8 illustrated in FIG. 8 can also be said to indicate the direction perpendicular to this split surface. Upon completion of the molding step, the upper die 51 moves in a direction opposite to the direction of arrow AR8 so that the molding die 50 is opened.

With L1 and L2 being defined as with the case of FIG. 12, L1×cos θ is smaller than L2 in the present embodiment. As a result, when viewed along arrow AR8, the blades 300 adjacent to each other do not overlap but form a gap G1 therebetween. The blades 300 and the like are molded in such a state, so that the die and the blades 300 do not interfere with each other at the time of die cutting. That is, the so-called “undercut” can be avoided.

The diameter of the first support 301 and the like, specifically the diameter of the columnar part 310, is denoted as “d” in FIG. 13. The distance (center-to-center distance) between the first support 301 and the second support 302 formed on the same blade 300 is denoted as L11 in FIG. 13. In the present embodiment, L11×cos θ is larger than “d”. As a result, when viewed along arrow AR8, the first support 301 and the second support 302 do not overlap but form a gap G2 therebetween. Similarly, when viewed along arrow AR8, the third support 303 and the fourth support 304 do not overlap but form the gap G2 therebetween. The blades 300 and the like are molded in such a state, so that the die and the first support 301 and the like do not interfere with each other at the time of die cutting.

Upon completion of the molding step, the upper die 51 moves upward while the first lower die 52 moves downward (in the direction of arrow AR5) as illustrated in FIG. 9(B). The molding die 50 is opened as a result. The illustration of the upper die 51 is omitted in FIG. 9(B) and FIGS. 9(C) and 9(D) described later.

Subsequently, the third slide die 56 moves in the direction of arrow AR6 as illustrated in FIG. 9(C). The third slide die 56 is a part that molds the fixed frame 100 and the movable frame 200 in the molding step. The third slide die 56 holds the lower horizontal part 120 of the fixed frame 100 and the lower horizontal part 220 of the movable frame 200 after the molding step is completed. Arrow AR6 in FIG. 9(C) indicates the direction along the longitudinal direction of the blades 300 and the direction in which the lower horizontal part 120 and the like are caused to move toward the blades 300.

Thus, both the lower horizontal part 120 and the lower horizontal part 220 move toward the blades 300 when the third slide die 56 moves in the direction of arrow AR6. As a result, the third support 303 is inserted through the insertion hole 112 of the lower horizontal part 120, and the fourth support 304 is inserted through the insertion hole 212 of the lower horizontal part 220.

Although not shown in FIG. 9(C), the fourth slide die 57 is a part that molds the fixed frame 100 and the movable frame 200 as the third slide die 56 does, and is a die member that holds the upper horizontal part 110 and the upper horizontal part 210. In the step of FIG. 9(C), the fourth slide die 57 moves in a direction opposite to the direction of arrow AR6. Accordingly, the upper horizontal part 110 and the upper horizontal part 210 both move toward the blades 300. As a result, the first support 301 is inserted through the insertion hole 112 of the upper horizontal part 110, and the second support 302 is inserted through the insertion hole 212 of the upper horizontal part 210.

In the step of FIG. 9(C), the third slide die 56 and the fourth slide die 57 being parts of the molding die 50 are moved as described above to allow the blades 300 to be supported by the fixed frame 100 and the movable frame 200. That is, FIG. 9(C) illustrates a state in which an assembling step of the manufacturing process of the shutter device 10 is performed.

FIG. 10(B) schematically illustrates a state in which the assembling step of FIG. 9(C) is completed in a way similar to that of FIG. 10(A). In the present embodiment, a projection (not shown) with a stopper mechanism is formed on the end face 101S, and a recess into which the projection is inserted is formed on the end face 102S. In the assembling step, the projection on the end face 101S is inserted into the recess on the end face 102S so that the two are snap-connected. The end face 101S and the end face 102S are thus in contact with each other in the state of FIG. 10(B) to integrate the vertical part 130 in one piece at the snap connection.

The snap connection as described above is similarly made between the end face 103S and the end face 104S, between the end face 201S and the end face 202S, and between the end face 203S and the end face 204S. Thus, the upper frame 101 and the lower frame 102 are integrated in one piece, and the upper frame 201 and the lower frame 202 are integrated in one piece in the state of FIG. 10(B).

The rotational angle of each blade 300 does not change and remains at the insertion angle while the assembling step is performed.

Upon completion of the assembling step, the third slide die 56 and the fourth slide die 57 are returned to their original positions. Subsequently, the first slide die 54 moves in the direction of arrow AR7 as illustrated in FIG. 9(D). The first slide die 54 is a part that molds the vertical part 130 of the fixed frame 100 in the molding step. The first slide die 54 holds the vertical part 130 of the fixed frame 100 after the molding step is completed. Arrow AR7 in FIG. 9(D) indicates the direction along the longitudinal direction of the lower horizontal part 120 and the direction in which the vertical part 130 is caused to move to a position directly above the vertical part 230.

Thus, the fixed frame 100 moves to the position directly above the movable frame 200 when the first slide die 54 moves in the direction of arrow AR7. At this time, the rotational angles of the blades 300 being supported by the fixed frame 100 and the movable frame 200 are changed as the fixed frame 100 moves. Specifically, the rotational angles change from the state illustrated in FIG. 8 to the state illustrated in FIG. 7.

In the step of FIG. 9(D), the first slide die 54 being a part of the molding die 50 is moved to move the movable frame 200 relative to the fixed frame 100 as described above, whereby the blades 300 are rotated about their respective rotational axes. That is, FIG. 9(D) illustrates a state in which a rotating step of the manufacturing process of the shutter device 10 is performed.

At the start of the rotating step, the rotational angle of each blade 300 is set at the insertion angle (see FIG. 8). At the end of the rotating step, the rotational angle of each blade 300 is set at an angle different from the insertion angle (see FIG. 7). Therefore, at the end of the rotating step, the blades 300 cannot be removed from the fixed frame 100 or the movable frame 200 by moving the blades 300 in the longitudinal directions thereof.

In the middle of the rotating step, specifically right before the end of the rotating step, the projections 331 and 341 formed on the first support 301 go over the projections 131 and 141 formed in the fixed frame 100, respectively. At the same time, the projections 331 and 341 formed on the second support 302 go over the projections 231 and 241 formed in the movable frame 200. Thus, after the end of the rotating step, the fixed frame can be moved in the direction of arrow AR3 in FIG. 7 but cannot be moved in the direction of arrow AR4.

Upon completion of the rotating step, the shutter device 10 is taken out from the molding die 50. The manufacturing method according to the present embodiment moves parts of the molding die 50 to be able to complete at once the assembling of the plurality of blades 300 to the fixed frame 100 and the assembling of the plurality of blades 300 to the movable frame 200. Adopting such an in-mold assembly method can prevent an increase in manufacturing cost when the number of blades 300 is increased.

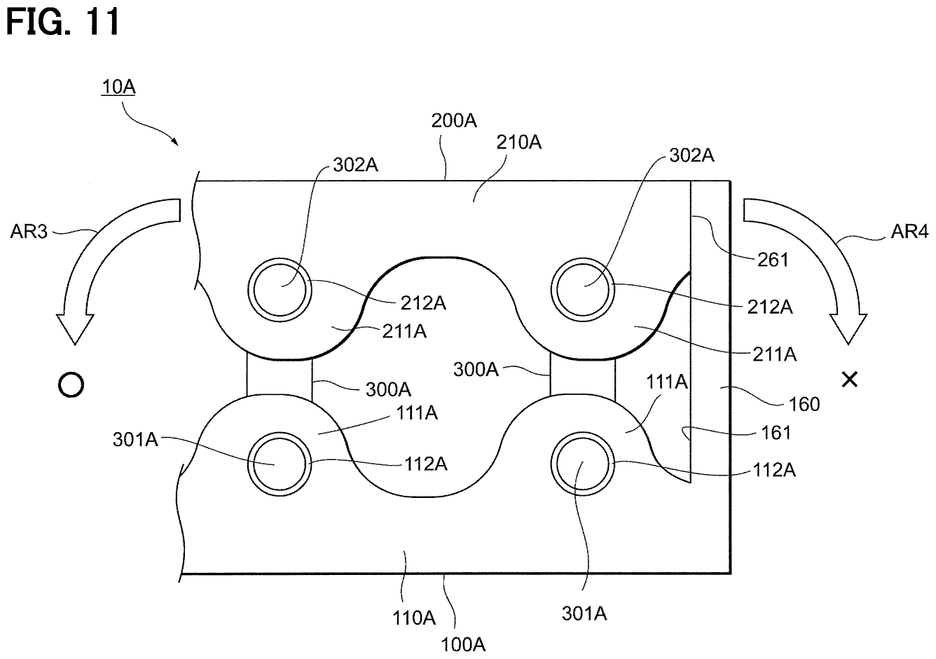

A second embodiment will be described with reference to FIG. 11.

A shutter device 10A according to the second embodiment is different from the first embodiment in terms of the configuration of parts where a fixed frame 100A and a movable frame 200A support blades 300A and the configuration of a stopper mechanism. The rest of the configuration is the same as that of the first embodiment. Only the differences from the first embodiment will be described below while description of points common to the first embodiment will be omitted.

In the present embodiment, four supports (a first support 301A, a second support 302A, a third support 303A, and a fourth support 304A) formed on the blade 300A each have a simple columnar shape. Insertion holes 112 and the like through which the respective supports are inserted each have a simple circular shape. FIG. 11 only illustrates the support structure for the first support 301A and the second support 302A. Illustration and description of the support structure for the third support 303A and the fourth support 304A will be omitted since the support structure is identical to vertical inversion of the support structure illustrated in FIG. 11.

In the present embodiment, the first support 301A and the like are only rotatably supported by the fixed frame 100A and the movable frame 200A, and include no formation of a stopper mechanism such as the protrusion 330 and the like. Even in such a mode, the fixed frame 100A and the movable frame 200A are bridged and connected by the plurality of blades 300A as with the first embodiment. Thus, the effect (i.e., the improvement of rigidity) identical to that of the first embodiment is obtained.

When an upper horizontal part 110A is made thin, for example, the first support 301A may come off the upper horizontal part 110 as the upper horizontal part 110A bends. It is thus desirable to form a stopper mechanism as in the first embodiment when the upper horizontal part 110A has low rigidity.

In the present embodiment, a stopper 160 is formed at a position corresponding to an end of the fixed frame 100A on the side of a vertical part 140 (on the right side in FIG. 11). The stopper 160 is a member having a plate shape and formed to extend from the fixed frame 100A toward the movable frame 200A (upward in FIG. 11). When the shutter device 10A is in the open state as illustrated in FIG. 11, a surface 161 of the stopper 160 on the side of the blade 300A is in contact with a side surface 261 of the movable frame 200A. The movable frame 200A can thus move in the direction of arrow AR3 but cannot move in the direction of arrow AR4 due to the stopper 160. The stopper 160 preventing the movement of the movable frame 200A thus prevents a change in the rotational angle of the blade 300. That is, the stopper 160 functions as a stopper mechanism similar to the projections 131, 141, 231, 241, 331, and 341 of the first embodiment.

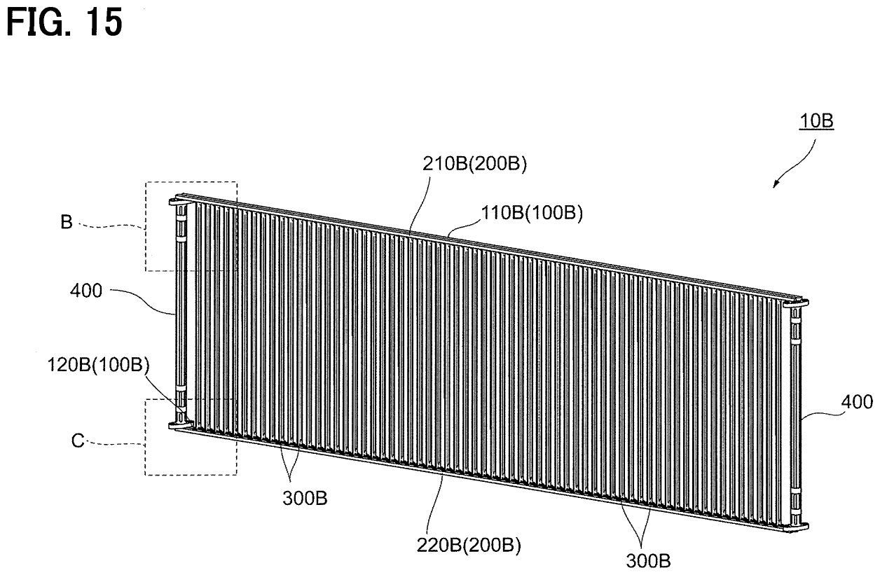

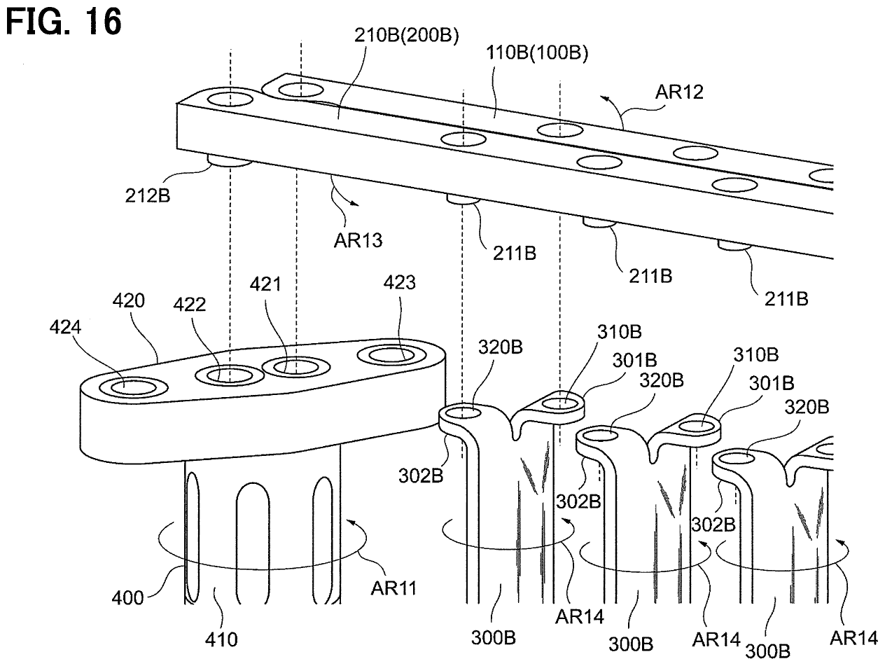

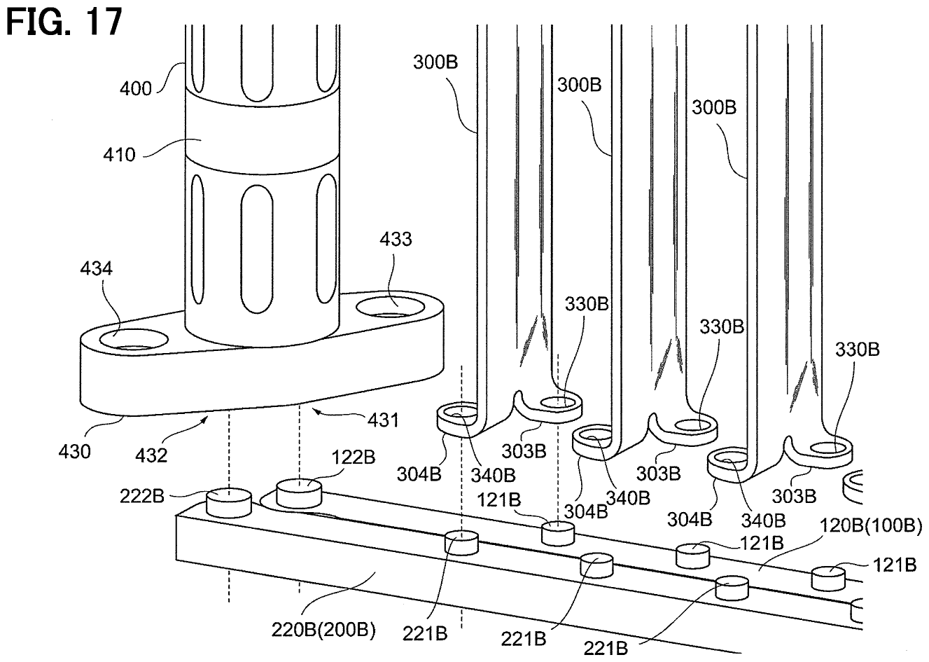

A third embodiment will be described with reference to FIGS. 15 to 17. FIG. 15 illustrates the overall configuration of a shutter device 10B according to the third embodiment. FIG. 16 is an exploded view illustrating the structure of area B in FIG. 15. FIG. 17 is an exploded view illustrating the structure of area C in FIG. 15. The shutter device 10B includes a blade 300B, a second frame 200B, a first frame 100B, and a connecting member 400.

The blade 300B is a member having a plate shape with a main surface thereof formed into a substantially rectangular shape. A plurality of the blades 300B is provided in the shutter device 10B. The blades 300B have a function similar to that of the blades 300 of the first embodiment. That is, each of the blades 300B functions as a member that switches between a state in which the air flow is cut off and a state in which the air flow is not cut off by rotating about a rotational axis along the longitudinal direction of the blade. FIGS. 15 to 17 illustrate a state in which each of the blades 300B is parallel to the passage of air, that is, a state in which the shutter device 10B is fully opened.

As illustrated in FIG. 16, a first support 301B and a second support 302B are formed on one end (upper end) of the blade 300B in the longitudinal direction thereof. Moreover, as illustrated in FIG. 17, a third support 303B and a fourth support 304B are formed on the other end (lower end) of the blade 300 in the longitudinal direction thereof.

The first support 301B is formed to extend in one direction perpendicular to the main surface of the blade 300B from a part of the blade 300B facing an upper horizontal part 110B described later (a part on the back side of the page in FIG. 16). A through hole 310B having a circular shape is formed to pass through the first support 301B in the vertical direction. The first support 301B is a part rotatably supported by the upper horizontal part 110B of the first frame 100B.

The second support 302B is formed to extend in a direction opposite to the direction of extension of the first support 301B from a part of the blade 300B facing an upper horizontal part 210B described later (a part on the front side of the page in FIG. 16). A through hole 320B having a circular shape is formed to pass through the second support 302B in the vertical direction. The second support 302B is a part rotatably supported by the upper horizontal part 210B of the second frame 200B.

The third support 303B is formed to extend in one direction perpendicular to the main surface of the blade 300B from a part of the blade 300B facing a lower horizontal part 120B described later (a part on the back side of the page in FIG. 17). The third support 303B extends in the same direction as the first support 301B. That is, the third support 303B is formed at a position below the first support 301B. A through hole 330B having a circular shape is formed to pass through the third support 303B in the vertical direction. The third support 303B is a part rotatably supported by the lower horizontal part 120B of the first frame 100B.

The fourth support 304B is formed to extend in one direction perpendicular to the main surface of the blade 300B from a part of the blade 300B facing a lower horizontal part 220B described later (a part on the front side of the page in FIG. 17). The fourth support 304B extends in the same direction as the second support 302B. That is, the fourth support 304B is formed at a position below the second support 302B. A through hole 340B having a circular shape is formed to pass through the fourth support 304B in the vertical direction. The fourth support 304B is a part rotatably supported by the lower horizontal part 220B of the second frame 200B.

The second frame 200B has a function similar to that of the movable frame 200 of the first embodiment, and is a member that rotatably supports the blades 300B. The second frame 200B includes the upper horizontal part 210B and the lower horizontal part 220B. The upper horizontal part 210B and the lower horizontal part 220B are provided as separate members in the present embodiment. In other words, the second frame 200B is divided into the upper horizontal part 210B and the lower horizontal part 220B.

Like the upper horizontal part 210 of the first embodiment, the upper horizontal part 210B of the second frame 200B is a member having a rod shape and disposed along the upper ends of the blades 300B. A plurality of projections 211B is formed on a surface (lower surface) of the upper horizontal part 210B facing the blades 300B. Each projection 211B has a columnar shape with a central axis thereof being parallel to the longitudinal direction of the blade 300B. Each projection 211B is formed at a position facing the through hole 320B of each blade 300B. The outer diameter of the projection 211B is slightly smaller than the inner diameter of the through hole 320B. The projection 211B is inserted into the through hole 320B from above while the central axis of the projection is aligned with the central axis of the through hole 320B as illustrated in FIG. 16. As a result, each second support 302B is rotatably supported by the upper horizontal part 210B.

Like the lower horizontal part 220 of the first embodiment, the lower horizontal part 220B of the second frame 200B is a member having a rod shape and disposed along the lower ends of the blades 300B. A plurality of projections 221B is formed on a surface (upper surface) of the lower horizontal part 220B facing the blades 300B. Each projection 221B has a columnar shape with a central axis thereof being parallel to the longitudinal direction of the blade 300B. Each projection 221B is formed at a position facing the through hole 340B of each blade 300B. The outer diameter of the projection 221B is slightly smaller than the inner diameter of the through hole 340B. The projection 221B is inserted into the through hole 340B from below while the central axis of the projection is aligned with the central axis of the through hole 340B as illustrated in FIG. 17. As a result, each fourth support 304B is rotatably supported by the lower horizontal part 220B.

The first frame 100B has a function similar to that of the fixed frame 100 of the first embodiment, and is a member that rotatably supports the blades 300B. The first frame 100B includes the upper horizontal part 110B and the lower horizontal part 120B. The upper horizontal part 110B and the lower horizontal part 120B are provided as separate members in the present embodiment. In other words, the first frame 100B is divided into the upper horizontal part 110B and the lower horizontal part 120B.

Like the upper horizontal part 110 of the first embodiment, the upper horizontal part 110B of the first frame 100B is a member having a rod shape and disposed along the upper ends of the blades 300B. A plurality of projections 111B is formed on a surface (lower surface) of the upper horizontal part 110B facing the blades 300B. The projections 111B are hidden by the second frame 200B in FIG. 16 and are not shown.

Like the projection 211B illustrated in FIG. 16, each projection 111B has a columnar shape with a central axis thereof being parallel to the longitudinal direction of the blade 300B. Each projection 111B is formed at a position facing the through hole 310B of each blade 300B. The outer diameter of the projection 111B is slightly smaller than the inner diameter of the through hole 310B. The projection 111B is inserted into the through hole 310B from above as the projection 211B is inserted into the through hole 320B from above. As a result, each first support 301B is rotatably supported by the upper horizontal part 110B.

Like the lower horizontal part 120 of the first embodiment, the lower horizontal part 120B of the first frame 100B is a member having a rod shape and disposed along the lower ends of the blades 300. A plurality of projections 121B is formed on a surface (upper surface) of the lower horizontal part 120B facing the blades 300B. Each projection 121B has a columnar shape with a central axis thereof being parallel to the longitudinal direction of the blade 300B. Each projection 121B is formed at a position facing the through hole 330B of each blade 300B. The outer diameter of the projection 121B is slightly smaller than the inner diameter of the through hole 330B. The projection 121B is inserted into the through hole 330B from below while the central axis of the projection is aligned with the central axis of the through hole 330B as illustrated in FIG. 17. As a result, each third support 303B is rotatably supported by the lower horizontal part 120B.

In the shutter device 10B of the present embodiment as well, the first support 301B rotatably supported by the first frame 100B and the second support 302B rotatably supported by the second frame 200B are formed side by side along the widthwise direction of the blade 300B on the upper end of the blade 300B. The third support 303B rotatably supported by the first frame 100B and the fourth support 304B rotatably supported by the second frame 200B are formed side by side along the widthwise direction of the blade 300B on the upper end of the blade 300B.

The expression “formed side by side along the widthwise direction of the blade 300B” means that the first support 301B and the second support 302B are formed at different positions in the widthwise direction of the blade 300B, for example, and does not mean that a straight line connecting the first support 301B and the second support 302B is parallel to the widthwise direction.

The connecting member 400 is a member provided to connect the upper horizontal part 110B, the lower horizontal part 120B, the upper horizontal part 210B, and the lower horizontal part 220B. In the present embodiment, a pair of the connecting members 400 is disposed at positions corresponding to both ends of the arrangement of the plurality of blades 300B.

The configuration of the connecting member 400 disposed on the left side in FIG. 15 will be described. As illustrated in FIGS. 16 and 17, the connecting member 400 includes a columnar part 410, an upper flange 420, and a lower flange 430. The columnar part 410 is a part having a substantially columnar shape and formed to extend along the longitudinal direction of the blades 300B.

The upper flange 420 is a flange formed at the upper end of the columnar part 410. The upper flange 420 is formed to extend in two directions that are opposite to each other and perpendicular to the longitudinal direction of the columnar part 410.

As illustrated in FIG. 16, recesses 421 and 422 each having a circular shape are formed to be recessed downward on the upper surface of the upper flange 420 at positions close to the center of the upper surface. The recess 421 is formed at the position facing the upper horizontal part 110B on the upper flange 420. The recess 422 is formed at the position facing the upper horizontal part 210B on the upper flange 420

A projection 212B having a columnar shape is formed on the lower surface of the upper horizontal part 210B at a position facing the recess 422. The outer diameter of the projection 212B is slightly smaller than the inner diameter of the recess 422. The projection 212B is inserted into the recess 422 from above while the central axis of the projection is aligned with the central axis of the recess 422. Thus, the upper horizontal part 210B is rotatably supported by the upper flange 420.

A projection 112B having a columnar shape is formed on the lower surface of the upper horizontal part 110B at a position facing the recess 421. The projection 112B is hidden by the second frame 200B in FIG. 16 and is not shown. The outer diameter of the projection 112B is slightly smaller than the inner diameter of the recess 421. The projection 112B is inserted into the recess 421 from above as the projection 212B is inserted into the recess 422 from above. Thus, the upper horizontal part 110B is rotatably supported by the upper flange 420.

A through hole 423 having a circular shape is formed near one edge of the upper flange 420 to pass through the upper flange 420 in the vertical direction. A through hole 424 having a circular shape is formed near the other edge of the upper flange 420 to pass through the upper flange 420 in the vertical direction. As a result, the through hole 423, the recess 421, the recess 422, and the through hole 424 are formed to line up along a straight line in the upper flange 420. The use of the through holes 423 and 424 will be described later.

Recesses 431 and 432 each having a circular shape are formed to be recessed upward on the lower surface of the lower flange 430 at positions close to the center of the lower surface. The recess 431 is formed at the position facing the lower horizontal part 120B on the lower flange 430. The recess 432 is formed at the position facing the lower horizontal part 220B on the lower flange 430.

As illustrated in FIG. 17, a projection 222B having a columnar shape is formed on the upper surface of the lower horizontal part 220B at a position facing the recess 432. The outer diameter of the projection 222B is slightly smaller than the inner diameter of the recess 432. The projection 222B is inserted into the recess 432 from below while the central axis of the projection is aligned with the central axis of the recess 432. Thus, the lower horizontal part 220B is rotatably supported by the lower flange 430.

A projection 122B having a columnar shape is formed on the upper surface of the lower horizontal part 120B at a position facing the recess 431. The outer diameter of the projection 122B is slightly smaller than the inner diameter of the recess 431. The projection 122B is inserted into the recess 431 from above while the central axis of the projection is aligned with the central axis of the recess 431. Thus, the lower horizontal part 120B is rotatably supported by the lower flange 430.

A through hole 433 having a circular shape is formed near one edge of the lower flange 430 to pass through the lower flange 430 in the vertical direction. A through hole 434 having a circular shape is formed near the other edge of the lower flange 430 to pass through the lower flange 430 in the vertical direction. As a result, the through hole 433, the recess 431, the recess 432, and the through hole 434 are formed to line up along a straight line in the lower flange 430. The use of the through holes 433 and 434 will be described later.

When the connecting member 400 is rotated about the central axis of the columnar part 410 as indicated by arrow AR11 in FIG. 16, the upper horizontal part 110B and the upper horizontal part 210B supported by the connecting member 400 move in the directions indicated by arrows AR12 and AR13, respectively. The lower horizontal part 120B and the lower horizontal part 220B supported by the connecting member 400 also move in a manner similar to that described above. As a result, each of the blades 300B rotates in the direction of arrow AR14 to gradually decrease the cross sectional area of a passage through which the air passes. Eventually, ends in the widthwise direction (that is, areas near the long sides) of the blades 300B adjacent to each other are brought into contact with each other. At this time, the blades 300 adjacent to each other form zero gap therebetween and zero cross sectional area of the passage through which the air passes, whereby the shutter device 10 is in the closed state.

In the present embodiment, the axis along the longitudinal direction of the blade 300B and running between the first support 301B and the second support 302B corresponds to the “rotational axis” of the blade 300B.

The shutter device 10B according to the present embodiment can thus change the opening thereof by rotating the connecting member 400. Both the first frame 100B and the second frame 200B move at this time unlike the case of the first embodiment. In other words, the second frame 200B moves relative to the first frame 100B. The effect similar to that described in the first embodiment is also obtained in such a mode.

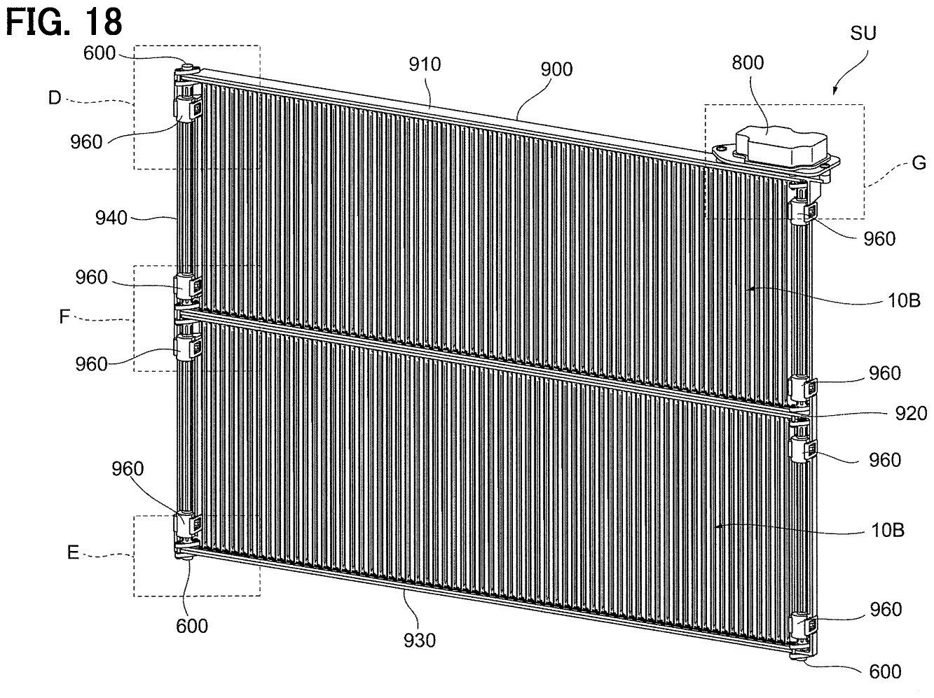

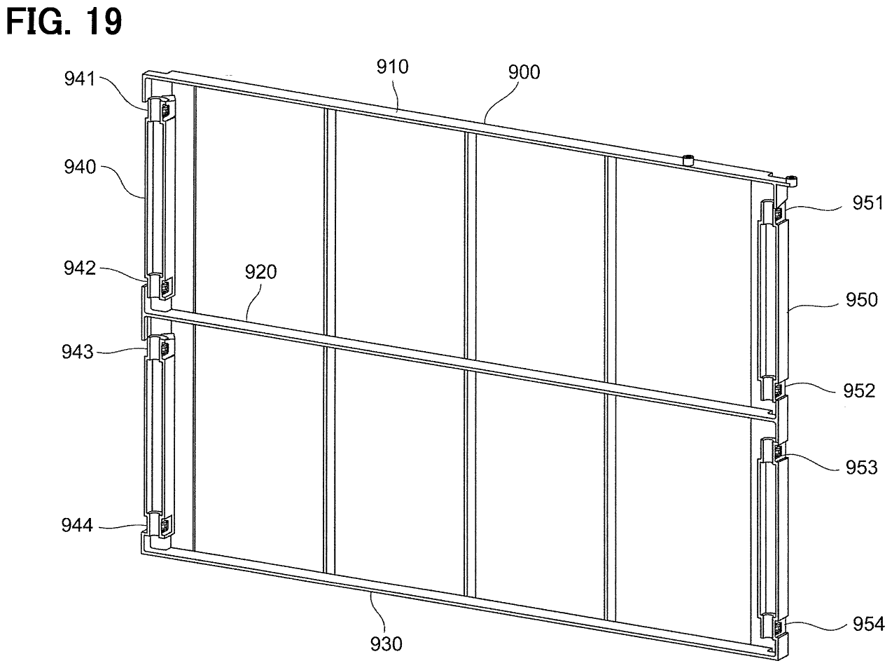

A shutter unit SU including a plurality of the shutter devices 10B will be described with reference to FIGS. 18 to 24. As illustrated in FIG. 18, the shutter unit SU is configured such that two shutter devices 10B are arranged vertically. Each of the shutter devices 10B is held by a frame 900 illustrated in FIG. 19. As will be described later, the shutter unit SU can change the opening of each of the shutter devices 10B by the driving force of an actuator unit 800.

As illustrated in FIG. 19, the frame 900 includes an upper plate 910, a lower plate 930, a middle plate 920, and vertical parts 940 and 950 to form a rectangular frame body as a whole.

The upper plate 910 is a part corresponding to the upper side of the frame 900 having the rectangular shape. The upper plate 910 is formed in a flat plate shape and is parallel to the upper horizontal part 110B of the shutter device 10B.

The lower plate 930 is a part corresponding to the lower side of the frame 900 having the rectangular shape. The lower plate 930 is formed in a flat plate shape and is parallel to the lower horizontal part 120B of the shutter device 10B.

The middle plate 920 is a part disposed between the upper plate 910 and the lower plate 930. The middle plate 920 is formed in a flat plate shape and is parallel to each of the upper plate 910 and the lower plate 930. The distance between the upper plate 910 and the middle plate 920 is substantially equal to the height dimension of the shutter device 10B. The distance between the lower plate 930 and the middle plate 920 is also substantially equal to the height dimension of the shutter device 10B.

The vertical part 940 is a part extending downward from a left end of the upper plate 910. The vertical part 940 is a part corresponding to the left side of the frame 900 having the rectangular shape. The vertical part 940 is connected to each of the left end of the upper plate 910, a left end of the middle plate 920, and a left end of the lower plate 930.

The vertical part 950 is a part extending downward from a right end of the upper plate 910. The vertical part 950 is a part corresponding to the right side of the frame 900 having the rectangular shape. The vertical part 950 is connected to each of the right end of the upper plate 910, a right end of the middle plate 920, and a right end of the lower plate 930.

As illustrated in FIG. 18, the shutter device 10B disposed on the upper part of the shutter unit SU is held between the upper plate 910 and the middle plate 920. The shutter device 10B disposed on the lower part of the shutter unit SU is held between the lower plate 930 and the middle plate 920. The connecting member 400 on the left side in each of the shutter devices 10B is disposed along the vertical part 940 and held by the vertical part 940. The connecting member 400 on the right side in each of the shutter devices 10B is disposed along the vertical part 950 and held by the vertical part 950.

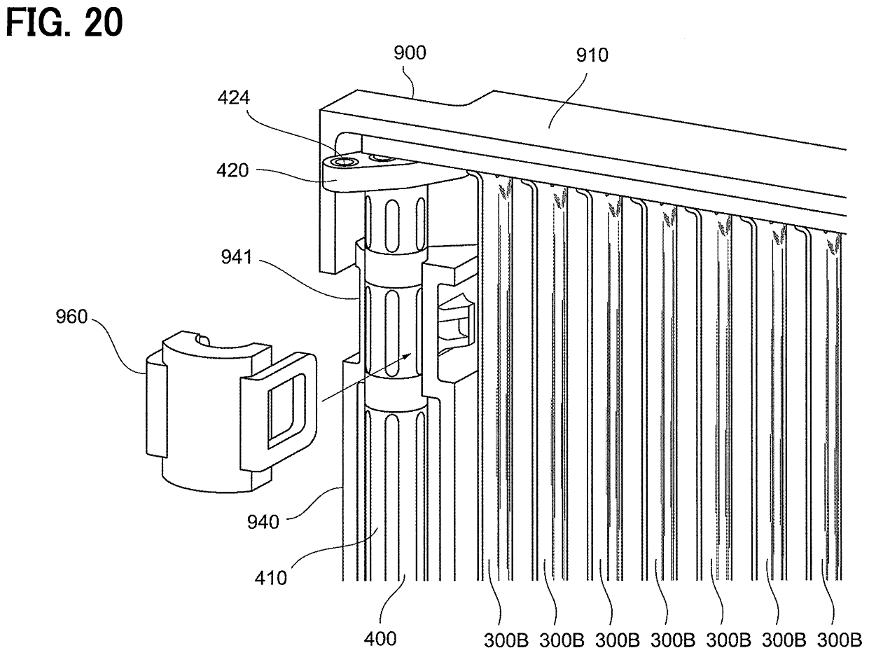

As illustrated in FIG. 19, holding parts 941 and 942 that hold the connecting member 400 are formed to be aligned vertically in the vertical part 940 above the middle plate 920. A holding member 960 is fitted into the holding part 941 in the direction of arrow as illustrated in FIG. 20. The connecting member 400 is rotatably held between the holding part 941 and the holding member 960. Similarly, the holding member 960 is fitted into the holding part 942 so that the connecting member 400 is rotatably held between the holding part 942 and the holding member 960.

As illustrated in FIG. 19, holding parts 943 and 944 that hold the connecting member 400 are formed to be aligned vertically in the vertical part 940 below the middle plate 920. Holding parts 951 and 952 that hold the connecting member 400 are formed to be aligned vertically in the vertical part 950 above the middle plate 920. Holding parts 953 and 954 that hold the connecting member 400 are formed to be aligned vertically in the vertical part 950 below the middle plate 920. The holding member 960 is fitted into each of the holding parts 943 and the like as described above, whereby the connecting member 400 is held rotatably.

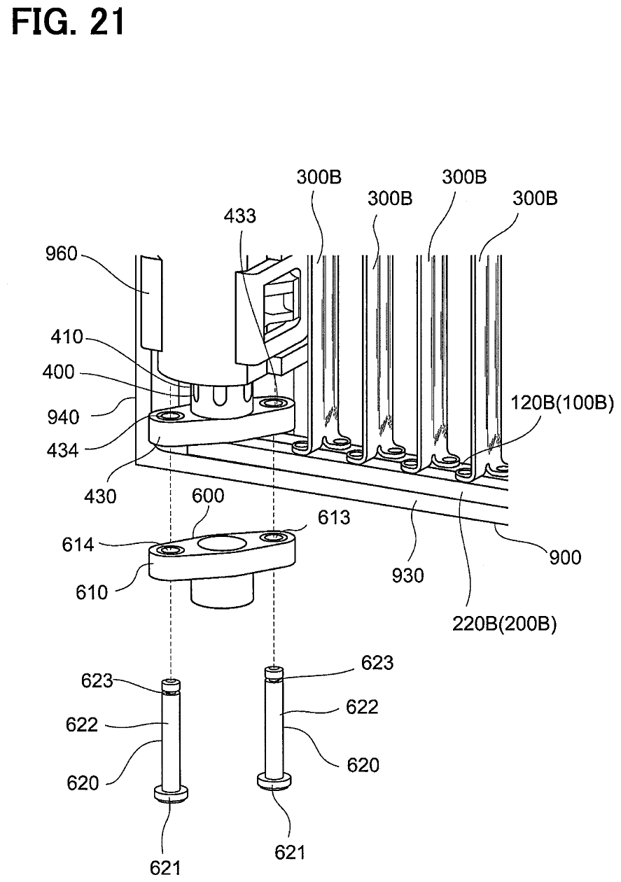

FIG. 21 is an exploded view illustrating the structure of area E in FIG. 18. As illustrated in the figure, a stopper member 600 is provided at a position below the lower flange 430 with the lower plate 930 interposed therebetween on the left side of the shutter unit SU. A flange 610 is formed in the upper part of the stopper member 600. Like the lower flange 430 of the connecting member 400, the flange 610 is formed to extend in two directions that are opposite to each other and perpendicular to the longitudinal direction of the columnar part 410.

A through hole 613 having a circular shape is formed near one edge of the flange 610 to pass through the flange 610 in the vertical direction. The central axis of the through hole 613 and the central axis of the through hole 433 located above the through hole 613 coincide with each other.

A through hole 614 having a circular shape is formed near the other edge of the flange 610 to pass through the flange 610 in the vertical direction. The central axis of the through hole 614 and the central axis of the through hole 434 located above the through hole 614 coincide with each other.

The stopper member 600 is fixed to the lower flange 430 by a pair of pins 620 while the lower plate 930, the lower horizontal part 120B, and the lower horizontal part 220B are interposed between the lower flange 430 and the stopper member. Each pin 620 includes a columnar part 622 and a flange 621. The columnar part 622 is a part having a columnar shape and formed to extend in the vertical direction. The outer diameter of the columnar part 622 is slightly smaller than the inner diameters of the through hole 613 and the through hole 433. A groove 623 being recessed is formed at a position near the upper end on the side surface of the columnar part 622.

The flange 621 is a circular flange formed to expand outward from the lower end of the columnar part 622. The diameter of the flange 621 is larger than the inner diameters of the through hole 613 and the through hole 433.

One of the pins 620 is inserted through both the through hole 613 and the through hole 433 from below the through hole 613. With the pin 620 inserted through both of the through holes, the groove 623 is exposed at a position slightly above the upper surface of the lower flange 430. A ring-shaped member (not shown) is fitted into the groove 623 in such a state. This prevents the pin 620 from coming off downward.

The other one of the pins 620 is inserted through both the through hole 614 and the through hole 434 from below the through hole 614. Similar to the above, a ring-shaped member (not shown) is fitted into the groove 623 to prevent the pin 620 from coming off downward.

The stopper member 600 is attached to the shutter unit SU as described above, thereby preventing the shutter device 10B from coming off the frame 900. As illustrated in FIG. 18, the stopper member 600 is also provided at the upper end of the vertical part 940 of the frame 900 and at the lower end of the vertical part 950 of the frame 900.

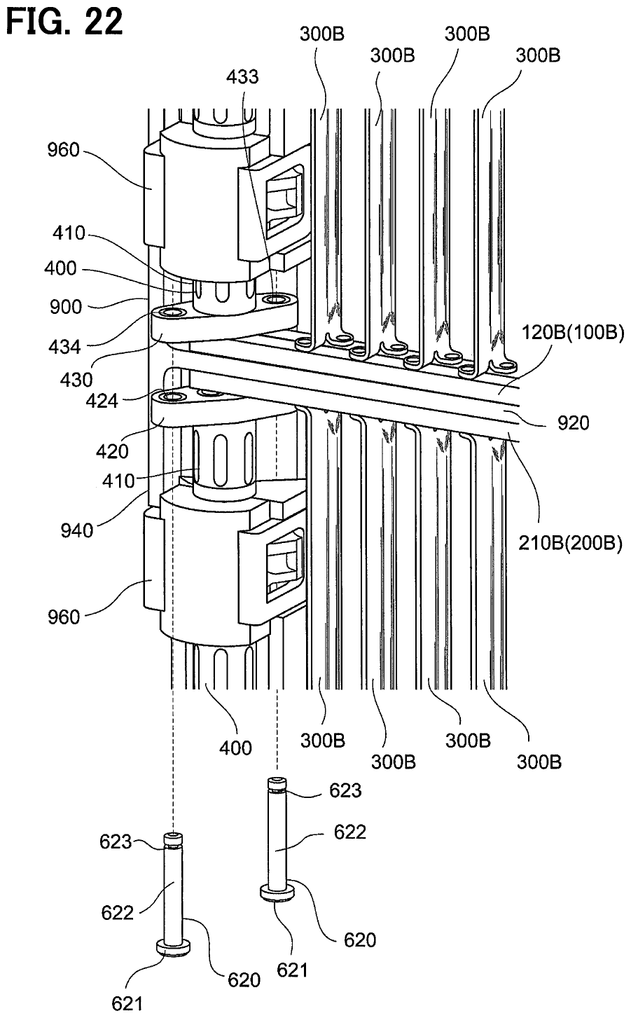

FIG. 22 is an exploded view illustrating the structure of area F in FIG. 18. As illustrated in the figure, the lower flange 430 of the connecting member 400 disposed on the upper side and the upper flange 420 of the connecting member 400 disposed on the lower side face each other while interposing the middle plate 920 and the like between the lower flange and the upper flange. The pin 620 is inserted through the through hole 423 and the through hole 433 from therebelow, the through holes facing each other vertically. The pin 620 is also inserted through the through hole 424 and the through hole 434 from therebelow, the through holes facing each other vertically. A ring-shaped member (not shown) is fitted into the groove 623 of each pin 620 to prevent the pin 620 from coming off downward.

The pair of connecting members 400 arranged vertically on the left side of the shutter unit SU are connected to each other by the pair of pins 620 as described above. Likewise, the connecting members 400 arranged vertically on the right side of the shutter unit SU are connected to each other by the pins 620. As a result, rotation of the connecting member 400 of the shutter device 10B disposed on the upper side causes the connecting member 400 of the shutter device 10B disposed on the lower side to rotate in the same direction as the rotation of the connecting member of the shutter device on the upper side. In other words, a change in the opening of the shutter device 10B disposed on the upper side causes a similar change in the opening of the shutter device 10B disposed on the lower side.

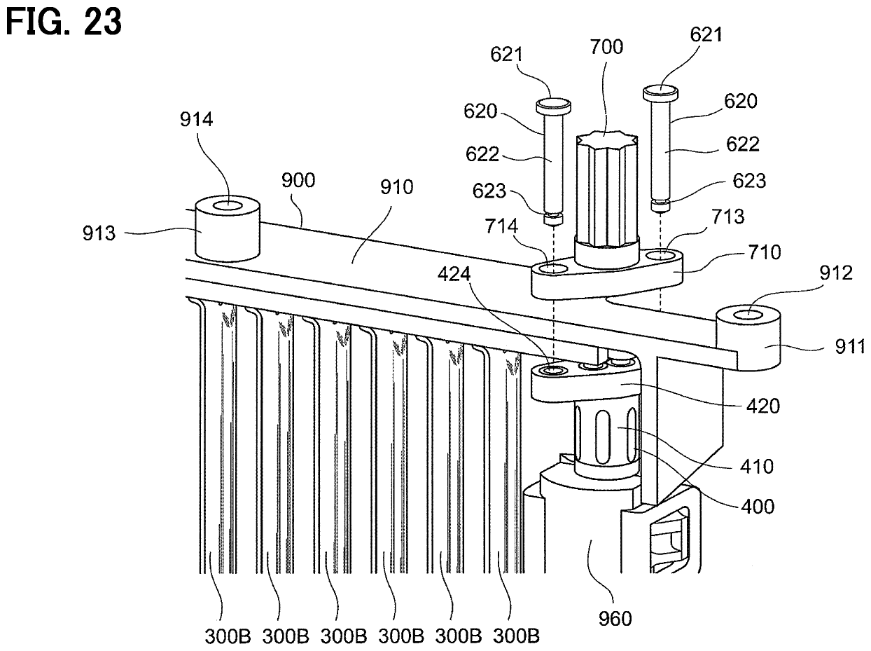

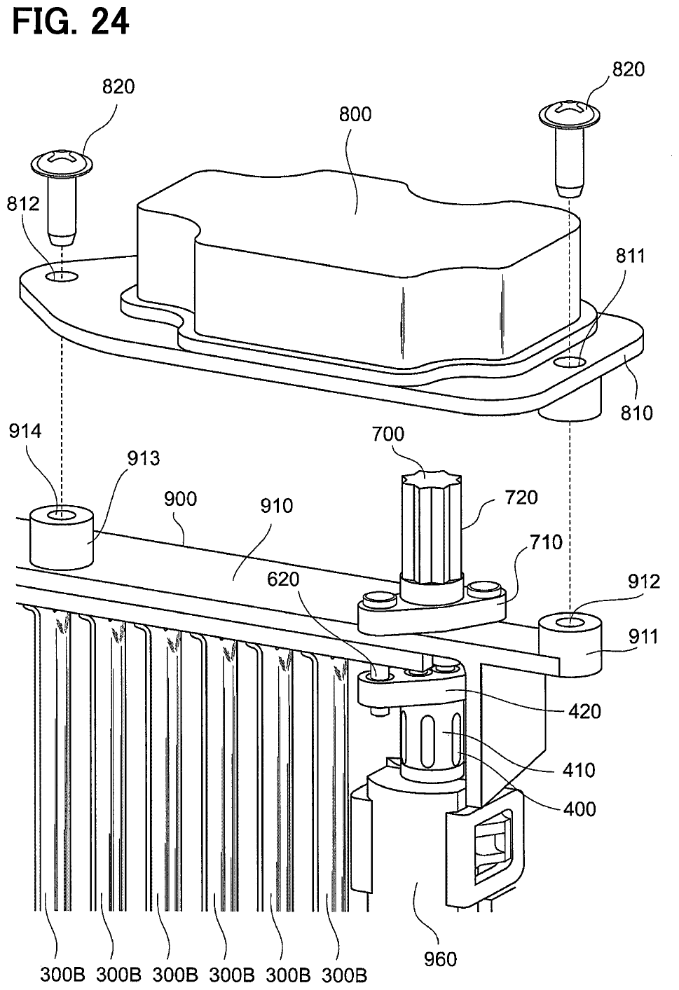

FIGS. 23 and 24 are each an exploded view illustrating the structure of area G in FIG. 18. FIG. 23 illustrates a state before the actuator unit 800 is attached.

As illustrated in FIG. 23, a driving member 700 is provided at a position above the upper flange 420 with the upper plate 910 interposed therebetween on the right side of the shutter unit SU. The driving member 700 is a member that transmits the driving force of the actuator unit 800 to the connecting member 400 therebelow and causes the connecting member 400 to rotate about the central axis thereof.

The driving member 700 includes a driven part 720 and a flange 710. The driven part 720 is formed in a columnar shape extending upward. A plurality of irregularities for receiving the driving force of the actuator unit 800 is formed on the side surface of the driven part 720.

Like the upper flange 420 of the connecting member 400, the flange 710 is formed to extend in two directions that are opposite to each other and perpendicular to the longitudinal direction of the driven part 720.

A through hole 713 having a circular shape is formed near one edge of the flange 710 to pass through the flange 710 in the vertical direction. The central axis of the through hole 713 and the central axis of the through hole 423 located below the through hole 713 coincide with each other.

A through hole 714 having a circular shape is formed near the other edge of the flange 710 to pass through the flange 710 in the vertical direction. The central axis of the through hole 714 and the central axis of the through hole 424 located below the through hole 714 coincide with each other.

The driving member 700 is fixed to the upper flange 420 by a pair of pins 620 while the upper plate 910, the upper horizontal part 110B, and the upper horizontal part 210B are interposed between the upper flange 420 and the driving member. The driving member is fixed by the same method as that used to fix the stopper member 600 as described with reference to FIG. 21. One of the pins 620 is stopped by a ring member (not shown) while being disposed to pass through the through hole 713 and the through hole 423 from above. The other one of the pins 620 is stopped by a ring member (not shown) while being disposed to pass through the through hole 714 and the through hole 424 from above. With the above configuration, rotation of the driven part 720 about the central axis thereof causes the connecting member 400 disposed therebelow to rotate in the same direction as the rotation of the driven part.

As illustrated in FIG. 24, fastened parts 911 and 913 protruding upward are formed in the upper plate 910. The fastened part 911 is formed at a position to the right of the driving member 700. A screw hole 912 for receiving a screw 820 is formed on the upper surface of the fastened part 911. The fastened part 913 is formed at a position to the left of the driving member 700. A screw hole 914 for receiving a screw 820 is formed on the upper surface of the fastened part 913.

The actuator unit 800 is a unit in which a rotary electric machine (not shown) is housed inside a container. A flange 810 extending to the side is formed at the lower end of the actuator unit 800. A through hole 811 passing through the flange 810 in the vertical direction is formed at a position directly above the screw hole 912 in the flange 810. A through hole 812 passing through the flange 810 in the vertical direction is formed at a position directly above the screw hole 914 in the flange 810.

The screw 820 is inserted through the through hole 811 and the screw hole 912 from above, and the screw 820 is also inserted through the through hole 812 and the screw hole 914 from above. The actuator unit 800 is thus fixed to the upper plate 910. The driven part 720 is disposed inside the actuator unit 800. When the rotary electric machine (not shown) included in the actuator unit 800 is driven, the driving force is transmitted to the driven part 720 so that the driving member 700 rotates about the central axis of the driven part 720. As a result, the openings of the shutter devices 10B arranged vertically are adjusted at the same time.

The present embodiment has been described with reference to specific examples. However, the present disclosure is not limited to these specific examples. Ones obtained by modifying the design of these specific examples as appropriate by a person skilled in the art are also included in the scope of the present disclosure as long as they have the characteristics of the present disclosure. The elements and their arrangements, conditions, shapes, and the like included in the specific examples described above are not limited to those exemplified but can be modified as appropriate. The elements included in the specific examples described above can be combined differently as appropriate as long as technical consistency is maintained.

What is claimed is:

1. A shutter device for a vehicle, the shutter device comprising:
blades that are a plurality of members each having a plate shape and being configured to rotate about a rotational axis along a longitudinal direction of each blade to switch between a state in which an air flow is interrupted by the blades and a state in which an air flow is not interrupted by the blades;
a first frame that is a member supporting the blades; and
a second frame that is a member supporting the blades and is movable relative to the first frame,
wherein:
one end of each of the blades in the longitudinal direction includes a first support rotatably supported by the first frame, and a second support rotatably supported by the second frame, and the first support and the second support are disposed along a widthwise direction of the blade; and
another end of each of the blades in the longitudinal direction includes a third support rotatably supported by the first frame, and a fourth support supported by the second frame, and the third support and the fourth support are disposed along the widthwise direction of the blade.

2. The shutter device according to claim 1, wherein a part of the first frame that supports the first support and a part of the first frame that supports the third support are separate from each other, and
a part of the second frame that supports the second support and a part of the second frame that supports the fourth support are separate from each other.

3. The shutter device according to claim 1, further comprising
a stopper mechanism that, when a rotational angle of each of the blades has been changed in a direction from the state in which the air flow is interrupted into a fully open state, prevents a further change in the rotational angle in the same direction.

4. The shutter device according to claim 3, wherein the stopper mechanism prevents the change in the rotational angle by preventing a movement of the second frame.

5. The shutter device according to claim 3, wherein the stopper mechanism prevents the change in the rotational angle by contact between a projection of the first frame and a projection of the first support and contact between a projection of the second frame and a projection of the second support.

6. The shutter device according to claim 1, wherein the first support, the second support, the third support, and the fourth support are each configured such that:
the blade is detachable from both the first frame and the second frame when a rotational angle of the blade is set at a predetermined insertion angle; and
the blade is undetachable from both the first frame and the second frame when the rotational angle of the blade is set at an angle different from the insertion angle.

7. The shutter device according to claim 1, wherein:
the first frame includes first protrusions protruding toward the second frame at a part of the first frame that supports the first support and a part of the first frame that supports the third support;
the second frame includes second protrusions protruding toward the first frame at a part of the second frame that supports the second support and a part of the second frame that supports the fourth support; and
in a fully closed state in which the air flow is interrupted, ends of the first protrusions are in contact with recesses that are formed between the second protrusions adjacent to each other in the second frame, and ends of the second protrusions are in contact with recesses that are formed between the first protrusions adjacent to each other in the first frame.

8. The shutter device according to claim 1, wherein:
each of the first support, the second support, the third support, and the fourth support has a shape including:
a columnar part that extends along the longitudinal direction of the blade from an end face of the blade; and
a protrusion that protrudes in a direction perpendicular to the longitudinal direction from an end of the columnar part; and
a distance from the end face to the protrusion is larger than a thickness of a part of the first frame or the second frame facing the end face.

9. The shutter device according to claim 1, wherein a length of the blade in the widthwise direction is longer than a distance between the blades adjacent to each other in a fully open state.

10. The shutter device according to claim 1, wherein the first frame is fixed to a vehicle body.

11. A method of manufacturing a shutter device for a vehicle,
the shutter device including:
blades that are a plurality of members each having a plate shape and being configured to rotate about a rotational axis along a longitudinal direction of each blade to switch between a state in which an air flow is interrupted by the blades and a state in which an air flow is not interrupted by the blades;
a first frame that is a member supporting the blades; and
a second frame that is a member supporting the blades and is movable relative to the first frame;
one end of each of the blades in the longitudinal direction includes a first support rotatably supported by the first frame and a second support rotatably supported by the second frame, and the first support and the second support are disposed along a widthwise direction of the blade;
another end of each of the blades in the longitudinal direction includes a third support rotatably supported by the first frame and a fourth support rotatably supported by the second frame, and the third support and the fourth support are disposed along the widthwise direction of the blade;
the method comprising:
molding all the blades, the first frame, and the second frame inside a molding die; and
assembling the blades, the first frame and the second frame by moving a part of the molding die such that each of the blades is supported by the first frame and the second frame.

12. The method of manufacturing a shutter device according to claim 11, further including, after the assembling,
rotating each of the blades about the rotational axis of each of the blades by moving the part of the molding die and moving the second frame relative to the first frame.

13. The method of manufacturing a shutter device according to claim 12, wherein
the first support, the second support, the third support, and the fourth support of the shutter device are each configured such that:
the blade is detachable from both the first frame and the second frame when the rotational angle of the blade is set at a predetermined insertion angle; and
the blade is undetachable from both the first frame and the second frame when the rotational angle of the blade is set at an angle different from the insertion angle,
the rotational angle is set at the insertion angle when the molding and the assembling are performed, and
the rotational angle is set at the angle different from the insertion angle when the rotating is completed.

14. The method of manufacturing a shutter device according to claim 13, wherein:
the shutter device includes a stopper mechanism that prevents a change in the rotational angle of the blade by contact between a projection of the first frame and a projection of the first support and contact between a projection of the second frame and a projection of the second support; and
at the time of the rotating, the projection of the first support moves beyond the projection of the first frame, and the projection of the second support moves beyond the projection of the second frame.

15. The method of manufacturing a shutter device according to claim 11, wherein at the time of the molding, the blades adjacent to each other are in a state free from overlap with each other when viewed from a direction perpendicular to both the longitudinal direction of the blades and a direction in which the blades are arranged.

16. The method of manufacturing a shutter device according to claim 11, wherein at the time of the molding, the first support and the second support are in a state free from overlap with each other, and the third support and the fourth support are in a state free from overlap with each other when viewed from a direction perpendicular to both the longitudinal direction of the blades and a direction in which the blades are arranged.
